(19) United States
(12) Patent Application Publication
(10) Pub. No.: US 2009/0136190 A1
(43) Pub. Date: May 28, 2009

(54) Optical Device Comprising a Waveguide Structure

(76) Inventors: Pierre Simon Joseph Berini, Orleans (CA); Robert Charbonneau, Kanata (CA); Nancy Lahoud, Kanata (CA)

Correspondence Address: ADAMS PATENT & TRADEMARK AGENCY, P.O. BOX 11100, STATION H, OTTAWA, ON, K2H 7T8, CA

(21) Appl. No.: 11/922,568

(22) PCT Filed: Jun. 29, 2006
(86) PCT No.: PCT/CA2006/001080

§ 371 Date: Dec. 19, 2007

Related U.S. Application Data
(60) Provisional application No. 60/694,667, filed on Jun. 29, 2005.
(60) Provisional application No. 60/794,825, filed on Apr. 26, 2006.

(51) Int. Cl. G02B 6/10; G02B 6/24

(52) U.S. Cl. 385/130; 385/38

(57) ABSTRACT

An optical device has a waveguide structure comprising a thin strip (12) having finite width and thickness of material having a relatively high free charge carrier density supported by a membrane (14) having a predetermined thickness of material that has a relatively low free charge carrier density. The dimensions of the width and thickness of the strip and the thickness of the supporting membrane are such that, when the waveguide structure is surrounded at least partially by an environment (E) having a low free charge carrier density, optical radiation having a wavelength in a predetermined range couples to the waveguide structure and propagates along the length thereof as a plasmon-polariton wave that permeates at least part of the environment (E).

### CROSS-REFERENCE TO RELATED APPLICATION

This application claims priority from U.S. Provisional patent applications Nos. 60/694,667 filed Jun. 29, 2005 and 60/794,825 filed Apr. 26, 2006, the contents of which are incorporated herein by reference.

### TECHNICAL FIELD

The invention relates to optical devices comprising a waveguide structure, particularly for guiding surface plasmon-polariton waves, and is especially, but not exclusively, applicable to optical devices for use in sensing constituents of or bodies in fluids.

### BACKGROUND

In the context of this patent specification:

The term “optical radiation” embraces electromagnetic waves having wavelengths in the infrared, visible and ultraviolet ranges.

The terms “finite” and “infinite” as used herein are used by persons skilled in this art to distinguish between waveguides having “finite” widths in which the actual width is significant to the performance of the waveguide and the physics governing its operation and so-called “infinite” waveguides where the width is so great that it has no significant effect upon the performance and physics of operation. Following this convention, dimensions in general that are said to be “optically infinite” or “optically semi-infinite” are so large that they are insignificant to the optical performance of the device.

The refractive index of a material is denoted n and is related to its relative permittivity εᵣ according to εᵣ= n². The relative permittivity εᵣ is related to the absolute permittivity ε via ε=εᵣε₀ where εₒ is the absolute permittivity of free space or vacuum.

A material said to have a “high free (or almost free) charge carrier density” is a material of a primarily metallic character exhibiting properties such as a high conductivity and a high optical reflectivity. Examples of such materials are (without limitation) metals, semi-metals and highly doped semiconductors.

A material said to have a “low free (or almost free) charge carrier density” is a material of a primarily dielectric character exhibiting properties such as a low conductivity. Examples of such materials are (without limitation) insulators, dielectrics, and undoped or lightly doped semiconductors

An environment said to have a “low free (or almost free) charge carrier density” includes a fluid having a primarily dielectric character exhibiting properties such as a low conductivity, and a vacuum.

Recognizing that, in practice, an absolute vacuum cannot be achieved, the term “vacuum” is used herein for an environment in which the effects of any residual material are negligible.

The term “fluid” used herein embraces gases, gaseous mixtures, (for instance air) and liquids (for instance aqueous).

The term “analyte” as used herein describes something that is to be detected or sensed within a prescribed environment (e.g., gaseous or aqueous), and can be, for example, a molecule, a biomolecule, a gas molecule, a virus, a bacterium, a spore, a particle, or any other body of interest. It may also be a constituent of a solution.

The term “adlayer” as used herein embraces at least one layer that is adhered or otherwise provided upon a surface. It also embraces surface chemistries.

U.S. Pat. Nos. 6,442,321 and 6,801,691, the contents of which are incorporated herein by reference, and to which the reader is directed for reference, each disclose a surface plasmon-polariton waveguide structure which comprises a strip of material of high free (or almost free) charge carrier density of thickness t, width w and permittivity ε₂ surrounded by an optically infinite homogeneous material of permittivity ε₁ having a low free (or almost free) charge carrier density. U.S. Pat. No. 6,442,321 teaches that one of the surface plasmon-polariton modes supported by this waveguide, the ss_{b}⁰ mode, exhibits a significant decrease in attenuation as the thickness and/or width of the strip tends towards zero with the mode changing into the plane optical wave supported by the background. As the strip dimensions decrease, the mode also expands, becoming less tightly bound to the strip and usually better matched to modes of dielectric optical waveguides (like single mode fibre) leading to efficient excitation via butt-coupling. Integrated optics elements such as bends, splitters, couplers and Mach-Zehnder interferometers constructed from this waveguide are also disclosed. This waveguide is not entirely satisfactory for use where at least part of the surrounding material should be a gas or a liquid.

U.S. Pat. Nos. 6,614,960 and 6,741,782, the contents of which are incorporated herein by reference and to which the reader is directed for reference, each disclose a surface plasmon-polariton waveguide structure similar to that disclosed in U.S. Pat. No. 6,442,321 and U.S. Pat. No. 6,801,691, but wherein the surrounding material comprises two distinct portions, one of which may be a fluid and the other a solid dielectric. In order for the ss_{b}⁰ mode to propagate, however, the material selected for the solid portion should have electromagnetic properties that, at least approximately, match those of the fluid at the wavelength and temperature of operation, which may limit application of the waveguide structure.

An object of the present invention is to overcome or at least mitigate limitations of the above-described known optical devices, or at least provide an alternative.

### SUMMARY OF THE INVENTION

According to the present invention, there is provided an optical device comprising a waveguide structure comprising:

a thin strip having finite width and thickness of material having a relatively high free charge carrier density supported by a membrane having a predetermined thickness of material that has a relatively low free charge carrier density,

the dimensions of the width and thickness of the strip and the thickness of the supporting membrane being such that, when the waveguide structure is surrounded at least partially by an environment (E) having a low free charge carrier density, optical radiation having a wavelength in a predetermined range couples to the waveguide structure and propagates along the length thereof as a plasmon-polariton wave that permeates at least part of the environment (E).

The membrane may cover a surface of the strip and be substantially non-invasive optically. Additionally or alternatively, the membrane may have a plurality of apertures spaced apart along its length, parts of the strip being exposed through respective ones of said apertures, and margin portions of the strip around the exposed parts overlying and being attached to respective parts of the membrane. The exposed parts of the strip may each extend into the respective one of the apertures.

Preferably, the optical device further comprises means for confining a said environment (E) that comprises either or both of a vacuum and a fluid and the membrane supports said strip such that at least said contacting portion extends at least partially within said the confined environment.

The membrane means may extend between spaced supports.

The membrane means may be permeable, apertured, porous or otherwise configured so as to allow the fluid or vacuum to contact the adjacent side of the strip through the membrane means. Such a membrane may allow both major surfaces of the strip to be exposed to the same fluid or vacuum environment, at least over a desired part of the strip.

In one preferred embodiment, for use in sensing a body in the environment, the strip comprises a material that reacts to the body. The strip then may be formed entirely from such material or may have a surface layer of such material, e.g., as an adlayer. Where the body to be sensed comprises analytes of, for example, a chemical or biological nature, the material, i.e., adlayer, may comprise receptors for binding with the analytes.

The optical device may further comprise means, for example a dielectric waveguide, for coupling input light endwise into one end of said strip so as to propagate along said strip as said plasmon-polariton wave.

Alternatively, the optical device may have means, for example a prism coupler or a grating patterned within a portion of the strip, for coupling input light laterally to said strip to propagate along the waveguide structure as said plasmon-polariton wave.

Whether the input light is coupled via said one end or laterally, the optical device may further comprise means, for example a dielectric waveguide, for extracting at least part of said plasmon-polariton wave endwise at an opposite end of said strip, or means, for example a prism coupler or a grating patterned within a portion of the strip, for extracting at least part of said plasmon-polariton wave laterally from said strip.

Various objects, features, aspects and advantages of the present invention will become more apparent from the following detailed description, taken in conjunction with the accompanying drawings, of preferred embodiments of the invention, which is provided by way of example only.

### BRIEF DESCRIPTION OF THE DRAWINGS

FIG. 1 is a plan view of a surface plasmon-polariton waveguide structure portion of an optical device embodying the present invention, showing optical input and output waveguide sections butt-coupled to the waveguide structure;

FIG. 2 is a side view of the surface plasmon-polariton waveguide structure portion of FIG. 1;

FIG. 3 is a partial cross-sectional perspective view of the surface plasmon-polariton waveguide structure taken on the line II-II of FIG. 1, without the optical input and output waveguide sections;

FIG. 4 is a cross-sectional end view of the surface plasmon-polariton waveguide structure also taken on the line II-II of FIG. 1 showing the optical output waveguide section;

FIG. 5 is a cross-sectional end view of a second embodiment wherein the waveguide structure extends within a tube;

FIG. 6 is a plot of the effective refractive index β/β₀ of the ss_{b}⁰ mode supported by the optical waveguide of FIG. 1 or 5 having a first set of parameters; the plot also shows the effective refractive index of the TE₀ and TM₀ modes supported by the membrane alone;

FIG. 7 is a plot of the attenuation of the ss_{b}⁰ mode supported by the waveguide structure having the first set of parameters;

FIGS. 8(a) and 8(b) are plots of the spatial distribution of Re{E_{y}} over the cross section for each of two specific geometries of the waveguide with the first set of parameters, plot 8(a) for d=1 nm, and plot 8(b) for d=20 nm;

FIG. 9 is a plot of the effective refractive index β/β₀ of the ss_{b}⁰ mode supported by a waveguide of FIG. 1 or 5 with a second set of parameters; the plot also shows the effective refractive index of the TE₀ and TM₀ modes supported by the membrane alone;

FIG. 10 is a plot of the attenuation of the ss_{b}⁰ mode supported by the waveguide with the second set of parameters;

FIGS. 11(a) and 11(b) are plots of the spatial distribution of Re{E_{y}} over the cross section for each of two specific geometries of the waveguide having the second set of parameters; plot 11(a) for d=1 nm, plot 11(b) for d=20 nm;

FIG. 12 is a plot of the effective refractive index β/β₀ of the ss_{b}⁰ mode supported by the waveguide of FIG. 1 or 5 with a third set of parameters; the plot also shows the effective refractive index of the TE₀ and TM₀ modes supported by the membrane;

FIG. 13 is a plot of the attenuation of the ss_{b}⁰ mode supported by the waveguide with the third set of parameters;

FIGS. 14(a) and 14(b) are plots of the spatial distribution of Re{E_{y}} over the cross section for each of two specific geometries of the waveguide having the third set of parameters; plot 14(a) for d=1 nm, plot 14(b) for d=20 nm;

FIG. 15 is a plot of the effective refractive index β/β₀ of the ss_{b}⁰ mode supported by the waveguide of FIGS. 1 to 5 with a fourth set of parameters; the plot also shows the effective refractive index of the TE₀ and TM₀ modes supported by the membrane alone;

FIG. 16 is a plot of the attenuation of the ss_{b}⁰ mode supported by the waveguide having the fourth set of parameters.

FIGS. 17(a) and 17(b) are plots of the spatial distribution of Re{E_{y}} over the cross section for each of two specific geometries of the waveguide having the fourth set of parameters; plot (a) for d=1 nm, plot (b) for d=20 nm;

FIG. 18 is a plot of the effective refractive index β/β₀ of the ss_{b}⁰ mode supported by the waveguide of FIG. 1 to 5 with a fifth set of parameters; the plot also shows the effective refractive index of the TE₀ and TM₀ modes supported by the membrane alone;

FIG. 19 is a plot of the attenuation of the ss_{b}⁰ mode supported by a waveguide having the fifth set of parameters;

FIGS. 20(a) and 20(b) are plots of the spatial distribution of Re{E_{y}} over the cross section for each of two specific geometries of the waveguide having the fifth set of parameters; plot (a) for d=1 nm, plot (b) for d=20 nm;

FIG. 21 is a simplified perspective view illustrating various optical elements implemented using the surface plasmon-polariton waveguide structure of either FIG. 1 or 5;

FIG. 22 is a plan view of a modification to either of the first and second embodiments;

FIG. 23 is a partial cross-sectional view taken on the line X-X of FIG. 22;

FIGS. 24 and 25 give the computed effective refractive index and computed attenuation, respectively, of the ss_{b}⁰ mode over a range of membrane thicknesses for a first example waveguide;

FIGS. 26(a) and 26(b) give the computed distribution of Re{E_{y}} over the waveguide cross-section for two specific waveguide geometries, respectively;

FIGS. 27 and 28 give the computed effective refractive index and computed attenuation of the ss_{b}⁰ mode over a range of membrane thicknesses of another example;

FIGS. 29(a) and 29(b) give the computed distribution of Re{E_{y}} over the waveguide cross-section for two specific waveguide geometries, respectively;

FIGS. 30(a), 30(b), 30(c) and 30(d) give the computed distribution of Re{E_{y}} over the waveguide cross-section for several sets of waveguide dimensions and operating parameters;

FIGS. 31(a) and 31(b) are an isometric view and a longitudinal cross-sectional view, respectively, of an alternative membrane waveguide structure;

FIGS. 32(a) and 32(b) are an isometric view and a top plan view, respectively, of another waveguide structure similar to that shown in FIGS. 31(a) and 31(b);

FIG. 32(c) shows a waveguide structure wherein the membrane width m is less than the trench diameter v;

FIGS. 33(a) and 33(b) are front and partial longitudinal cross-section views, respectively, of a modified waveguide structure having two prism couplers interfacing input and output fibers, respectively, with its top surface;

FIGS. 33(c) and 33(d) illustrate addition of optional spacing rails to the waveguide structure of FIGS. 33(a) and 33(b);

FIG. 34 is a partial side view of the waveguide structure of FIGS. 33(a) and 33(b);

FIG. 35 illustrates fiber to fiber insertion loss for various lengths of a waveguide arrangement as depicted in FIG. 33(a) and FIG. 34, a microscope image of a typical fabricated structure being shown inset;

FIG. 36 illustrates fiber to fiber insertion loss for various lengths of waveguide having a clamped membrane as shown in FIGS. 31(a) and 31(b), a microscope image of a typical fabricated structure being shown inset;

FIG. 37 illustrates a waveguide structure having scattering means defined lithographically on a top surface of the strip;

FIG. 38 is a schematic transverse cross-sectional view of a waveguide structure having an adlayer located along the top surface of the strip;

FIG. 39 gives the computed sensitivity ∂n_{eff}/∂α in nm⁻¹ of the ss_{b}⁰ mode over ranges of strip and membrane thickness t and d for the adlayer waveguide structure of FIG. 38;

FIG. 40 gives the computed sensitivity ∂n_{eff}/∂α in nm⁻¹ of the ss_{b}⁰ mode over a different range of strip and membrane thickness t and d for the adlayer waveguide structure of FIG. 38;

FIG. 41(a) shows schematically a Mach-Zehnder interferometer embodying the invention and having a Y-j unction combiner at its output;

FIG. 41(b) shows schematically a Mach-Zehnder interferometer similar to that of FIG. 41(a) but with the Y-junction combiner replaced with a dual-output coupler;

FIG. 41(c) shows schematically a Mach-Zehnder interferometer similar to that shown in FIG. 41(b) but with a triple-output coupler;

FIG. 42 shows an alternative arrangement of Mach-Zehnder interferometer for confining the environment E in a single channel such that the environment surrounds both the sensing and reference branches;

FIGS. 43(a) to (e) illustrate implementation of the Mach-Zehnder interferometer shown schematically in FIG. 42;

FIGS. 44(a) to (e) correspond to FIGS. 43(a) to (e) but of an arrangement in which the output prism-like coupler is replaced with a scattering centre;

FIGS. 45(a) to (e) are, respectively, cross-sectional, plan, end and side views of a physical implementation of the interferometer of FIG. 41(a);

FIGS. 46(a) and 46(b) are a schematic transverse cross-section view and a side view, respectively, of a waveguide structure resulting from the combination of the bottom chip shown in FIGS. 45(a)-(c) and the top chip shown in FIGS. 45(d)-(e); and

FIG. 46(c) shows an expanded partial cross-sectional view of the assembly taken along one of the branches;

FIG. 47(a) shows a low-magnification microscope image of a typical fabricated triple output equal arm Mach-Zehnder interferometer structure; FIGS. 47 (b), (c) and (d) give higher magnification images of a portion of the triple output coupler, the input section with the input splitter and the three output sections, respectively, of the structure shown in FIG. 47 (a);

FIG. 48 shows a plot of G as a function of the operating free-space wavelength for six combinations of t and d for the adlayer waveguide structure of FIG. 38;

FIG. 49 gives the computed sensitivity ∂n_{eff}/∂α in nm⁻¹ of the ss_{b}⁰ mode over a different range of strip and membrane thickness t and d for the adlayer waveguide structure of FIG. 38;

FIG. 50 (a) shows a low magnification microscope image of a typical fabricated single output Mach-Zehnder interferometer structure having electrical contacts to both branches; and

FIG. 50 (b) shows a high magnification image of a portion of the structure shown in FIG. 50 (a), showing electrical contacts to the strips and isolation gaps.

### DETAILED DESCRIPTION OF PREFERRED EMBODIMENTS

### Waveguide Structure

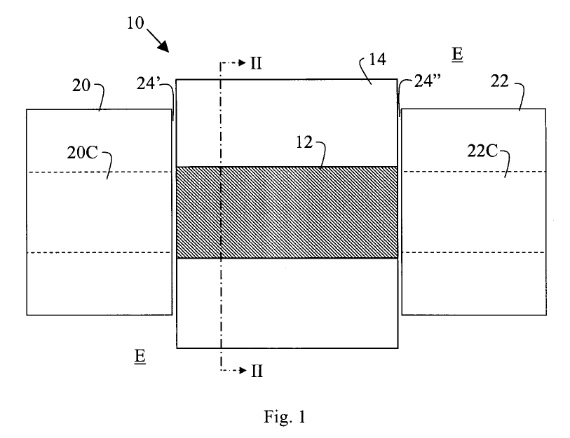

Referring to FIGS. 1, 2, 3 and 4, an optical device 10 comprises a surface plasmon-polariton waveguide structure comprising a strip 12 of material of high free (or almost free) charge carrier density and having thickness t, width w and permittivity ε₃, supported by a membrane 14 of material of low free (or almost free) charge carrier density of thickness d and permittivity ε₂, in an environment E of low free (or almost free) charge carrier density of permittivity ε₁. The strip 12 is attached, specifically adhered, to the membrane 14, preferably during fabrication.

The membrane 14 of width m extends across the mouth of a channel or cavity 16, shown here rectangular in section, provided in a substrate 18, leaving longitudinal supports 18A and 18B on either side of the channel 16. Opposite margin portions 14A and 14B of the membrane 14 overlie and are attached to distal end surfaces 18A′ and 18B′, respectively, of the supports 18A and 18B, conveniently by bonding during fabrication.

The ends of the channel 16 are open so that, in the region of the waveguide structure, the environment E is partitioned by the membrane 14 into optically semi-infinite portions, each portion extending away from the membrane 14 in the direction perpendicular to the width w of the strip 12.

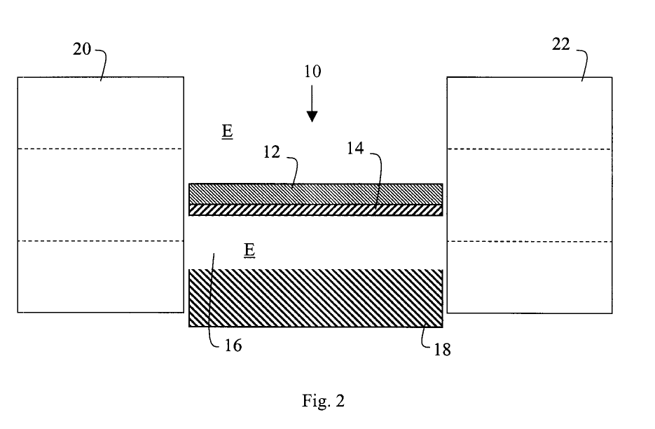

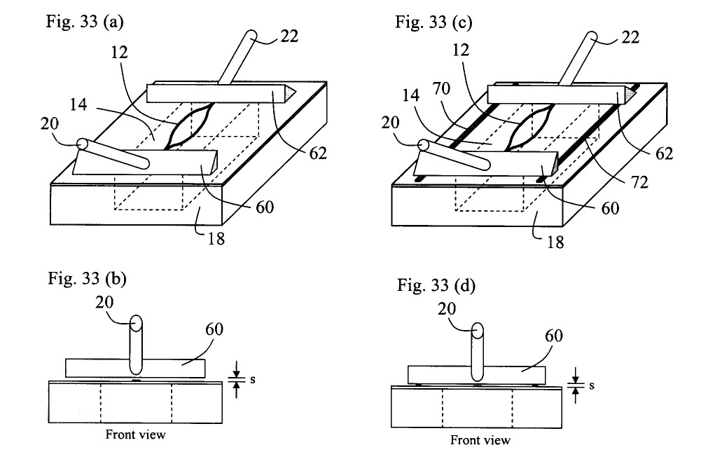

As shown in FIGS. 1 and 2, an optical input waveguide 20 and an optical output waveguide 22, conveniently dielectric waveguides in integrated optics circuits, or optical fibers, are butt-coupled to respective ends of the waveguide structure. Small gaps 24′ and 24″ between the ends of the waveguides 20 and 22, respectively, and the “abutting” ends of the waveguide structure (strip 12, membrane 14 and environment E) facilitate optical coupling and reduce the risk of damage to the strip 12 and membrane 14. Alternatively, coupling can be achieved via the top surface using prism couplers, as will be described in more detail later with reference to FIGS. 33 to 37.

The interior of the channel 16 is in communication with the portion of the environment E at the opposite surface of the membrane 14, i.e., which carries the strip 12. Thus, the environment E is substantially the same each side of the strip 12 and membrane 14. It should be noted that the membrane 14 is not considered to be part of the environment.

A second channel (not shown) could be provided, conveniently perpendicular to the channel 16, either meeting the first channel 16 to form a T-shaped channel arrangement or extending across the first channel 16 to form a cruciform channel arrangement open at one or two ends. Such a T-shaped or cruciform channel arrangement would facilitate circulation between the environment portions at opposite sides of the strip 12.

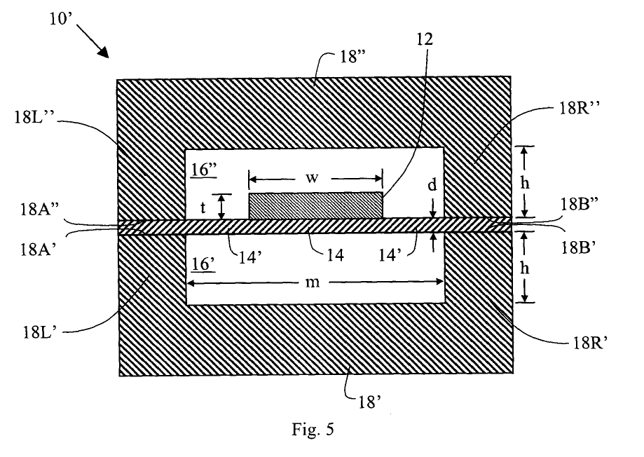

FIG. 5 is a cross-sectional view of a second embodiment that is similar to that shown in FIGS. 1, 2, 3 and 4 but differs in that the membrane 14 extends across the middle of a tube formed from cavities 16′ and 16″ shown as having a rectangular cross-section, conveniently formed by two U-shaped channel members 18′, 18″ similar to substrate 18 of the first embodiment joined along juxtaposed longitudinal edges 18A′, 18A″ and 18B′, 18B″ of their respective support ridges. As before, the strip 12 is attached, specifically adhered, to the membrane 14, preferably during fabrication, so that it extends longitudinally along the tubular axis. Such an arrangement facilitates manipulation of the environment portions on opposite sides of the strip 12.

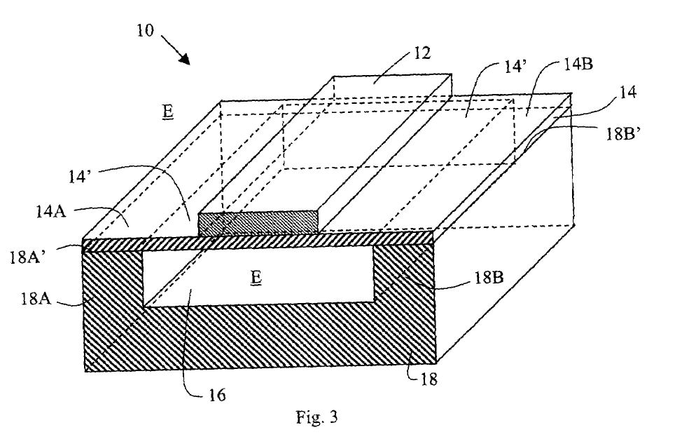

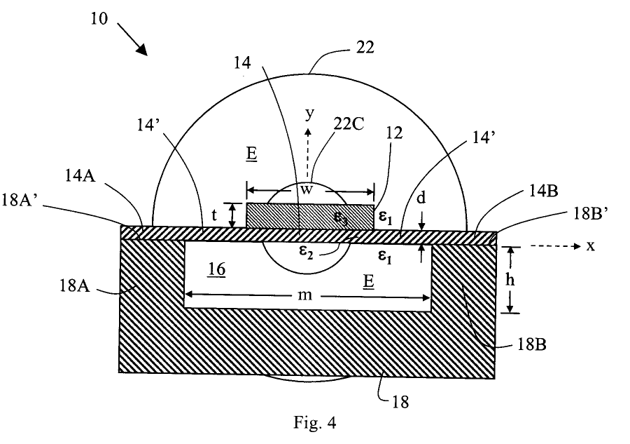

Although the strip 12 is shown in FIGS. 3 and 4 on the surface of membrane structure 14 remote from the substrate 18, it could be on the surface of the membrane structure facing the substrate 18.

A thin, protective covering could be provided over that surface of the strip 12 shown uppermost in FIG. 2, for example to isolate it from the fluid in the environment. Alternatively, the strip 12 could be encapsulated within the membrane 14 itself.

Although the channel 16 and tube formed from the cavities 16′ and 16″ are each shown with a rectangular cross-section, other cross-sectional shapes may be used.

As shown in FIG. 1 the cores 20C and 22C of the waveguides 20 and 22, respectively, are shown as having diameters approximately equal to the width of the strip 12. However, the strip width w could be made larger or smaller than the core diameter according to whether or not coupling loss was to be minimized, which would entail mode-matching between the waveguide(s) and the strip 12.

In both of the above-described embodiments, the membrane 14 is suspended between supports 18A, 18B. It is envisaged, however, that other forms of support could be used; for example a membrane and four pillars at its respective corners, or a membrane with four ligatures suspending its four corners, or held by one or more cantilevers, or a membrane with ligatures spaced apart along its length and coupled to a longitudinal support, and so on, providing the membrane means and, where applicable, its support(s), remain substantially non-invasive optically in the vicinity of the strip 12. It is also desirable for the membrane 14 to be subjected to a tensile or slightly tensile stress to ensure that it will be taut.

In either of the above-described embodiments, although the strip 12 is shown in the middle of the membrane 14, it could be offset to either side.

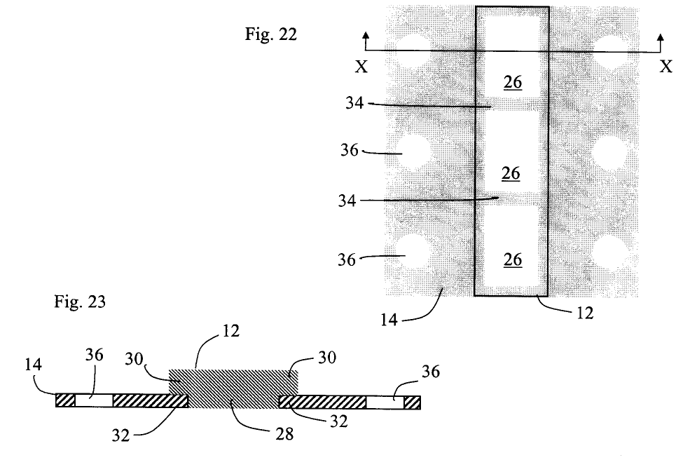

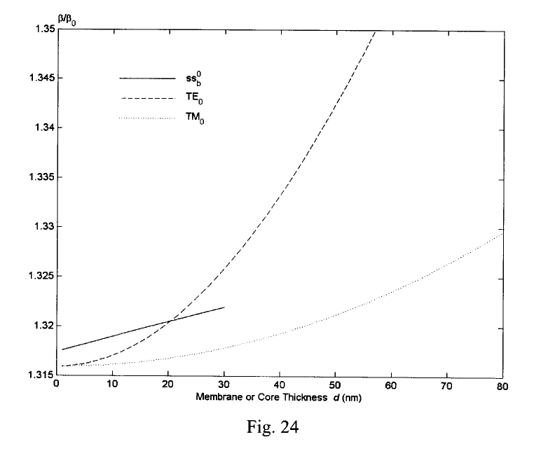

FIGS. 22 and 23 illustrate a modification applicable to either of the above-described embodiments. The modification entails providing a series of apertures 26, conveniently but not necessarily rectangular, as shown, along the length of the membrane 14 so that both major surfaces of the strip 12 are exposed to (contact) the environment E. As shown, the whole of the uppermost major surface is exposed, but only part of the lowermost major surface is. That is because the width of each of the apertures 26 is less than the width of the strip 12 so that, as shown in FIG. 23, a medial portion 28 of the strip 12 protrudes into each aperture 26 (so their respective lowermost surfaces are flush) leaving opposite lateral edge portions 30 of the strip 12 overlying the regions 32 of the membrane 14 around the apertures 26. The strip 12 will, of course, also overlie the membrane divider portions 34 separating the apertures 26, as shown in FIG. 22. Two rows of through holes 36 along opposite sides of the membrane 14 allow communication between the environment portions on opposite sides of the membrane 14 and strip 12.

In waveguide structures embodying the present invention, the materials, dimensions and environment E are selected such that optical radiation can be coupled to the strip 12 and will propagate along the strip 12 as a surface plasmon polariton wave. Moreover, the environment E may be selected according to the particular field of application or purpose of the optical device 10. Examples of suitable materials are set out below.

Suitable materials for the membrane 14 include good optical dielectrics such as (but not limiting to) glass, quartz, polymer, SiO₂, Si₃N₄, silicon oxynitride (SiON), LiNbO₃, PLZT, and undoped or very lightly doped semiconductors such as GaAs, InP, Si and Ge. Preferred materials for the membrane 14 are SiO₂, SiON and Si₃N₄ due to their strength and chemical stability, with Si₃N₄ and nitride rich SiON being particularly preferred due to the tensile nature of the stress that develops within the material when deposited using standard deposition techniques. Since the margin portions 14A and 14B of the membrane 14 will be held by the mechanical supports 18A and 18B, a tensile or slightly tensile stress ensures that it will be taut. Polymers that would be suitable for the membrane include, for example, BCB, polyimide, PMMA, Teflon AF (TM), SU8 and so on.

Suitable materials for the strip 12 include good conductors such as (but not limiting to) metals, semi-metals, highly n- or p-doped semiconductors or any other material that behaves like a metal. Suitable metals for the strip 12 may comprise a single metal or a combination of metals (alloys or laminates), conveniently selected from the group Au, Ag, Cu, Al, Pt, Pd, Ti, Ni, Mo and Cr. Metal silicides such as CoSi₂ are particularly suitable when the membrane material is Si. Suitable semiconductors for the strip 12 include highly n- or p-doped GaAs, InP, Si and Ge. Materials that behave like metals at the operating wavelength may also be used, such as Indium Tin Oxide (ITO). Preferred materials for the strip 12 are Au, Ag, Cu and Al, with Au being particularly preferred due to its chemical stability.

Suitable materials for the substrate 18 include the materials identified above for the membrane 14, with the preferred material being Si.

The environment may comprise matter in the gaseous, liquid or solid states, for example (but not limiting to), air, water or SiO₂, respectively. Alternatively, the environment may be vacuum.

### Design Considerations:

Embodiments of the invention comprise a composite waveguide structure: the membrane 14, when taken alone, supports a spectrum of bound dielectric optical slab modes and the strip 12, when taken alone, supports a spectrum of bound surface plasmon-polariton modes. The modes of interest are those of the composite structure, and the mode of particular interest is the ss_{b}⁰ mode.

Confinement of the ss_{b}⁰ mode in the direction perpendicular to the plane of the width of the strip 12 (referred to as “vertical” for convenience) is achieved by ensuring that the effective refractive index (n_{eff}=β/β₀, where β₀=2π/λ₀ is the phase constant of free space and λ₀ is the free-space wavelength) of the ss_{b}⁰ mode is greater than the refractive index of the environment E. At the same time, confinement of the ss_{b}⁰ mode in the direction parallel to the width of the strip 12, (“horizontal” for convenience) is achieved by ensuring that its effective refractive index is greater than that of the TE₀ and TM₀ modes supported by the membrane-only regions 14′ on either side of the strip 12 (shown in FIGS. 3, 4 and 5). Strictly speaking, if this latter condition is not met, then radiation leakage can occur via coupling into the TE₀ and TM₀ modes guided by membrane 14 in directions away from the strip 12. In practice, however, coupling into the TE₀ mode, which is horizontally polarized, is in general insignificant since the ss_{b}⁰ mode is substantially TM (substantially vertically polarized) and so is orthogonal to the TE₀ mode.

Designing a waveguide structure embodying this invention entails selecting materials and dimensions such that the ss_{b}⁰ mode is confined as described above, has a desired propagation constant (effective refractive index β/β₀ and attenuation α; the mode power attenuation in dB/m is given by α20 log₁₀(e)) and an appropriate mode field distribution. What constitutes “desired” and “appropriate” will depend upon the application. For example, to minimize insertion loss, it would be “desirable” to have low waveguide attenuation and low coupling losses to the input and output means. In the case where the input and output means correspond to other waveguides butt-coupled to the structure, an “appropriate” field distribution is that distribution that at least approximately matches the distribution of the mode field of the waveguide used as the butt-coupled input and output waveguides. Furthermore, the mode field used as the excitation preferably is polarization-aligned with the ss_{b}⁰ mode, which is substantially TM (substantially vertically polarized).

As mentioned above, the membrane 14 should not be too invasive optically, placing an upper bound on its optical thickness. It should also be mechanically sound so as to provide the required support, placing a lower bound on its physical thickness. Furthermore, it should be sufficiently wide that the supports 18A and 18B are far enough from the strip 12 to be non-invasive optically, placing a lower bound on its width m.

Using computer modeling techniques as disclosed in U.S. Pat. No. 6,442,321 (supra), the waveguide structure was analyzed in depth for different combinations of materials and dimensions for the strip 12 and membrane 14, in a vacuum or water environment E, at several typical operating wavelengths. Operation in a gaseous environment such as air is comparable optically to operation in vacuum and operation in an aqueous environment such as a biochemical buffer is comparable to operation in pure water. The analysis involved generating numerically the ss_{b}⁰ mode supported by a particular waveguide case, in the manner described in U.S. Pat. No. 6,442,321.

For purposes of illustration, and without limiting the scope of the present invention, several examples of a variety of combinations of materials and dimensions will now be described, together with the analysis of the resulting waveguide structure.

### EXAMPLE 1

The free-space operating wavelength was set to 1550 nm, SiO₂ (ε_{r,2}=1.444²) was selected as the material of the membrane 14, Au (ε_{r,3}=−131.95−j12.65) was selected as the material of the strip 12, and vacuum (ε_{r,1}=1) was selected as the environment E. The width w of the strip 12 was set to 8 μm, its thickness t was set to 30 nm, and the thickness d of the membrane 14 was varied from substantially 0 to about 65 nm for the purpose of illustrating its impact on the performance of the waveguide.

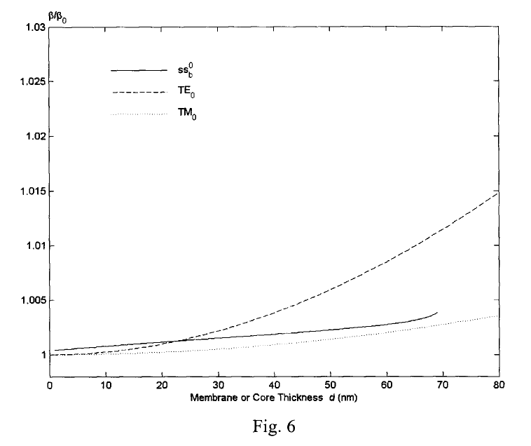

FIG. 6 gives the computed effective refractive index β/β₀ of the ss_{b}⁰ mode over the range of membrane thicknesses d. The effective refractive index of the TE₀ and TM₀ modes supported by the membrane 14 alone (i.e.: without the strip 12) was also plotted for reference.

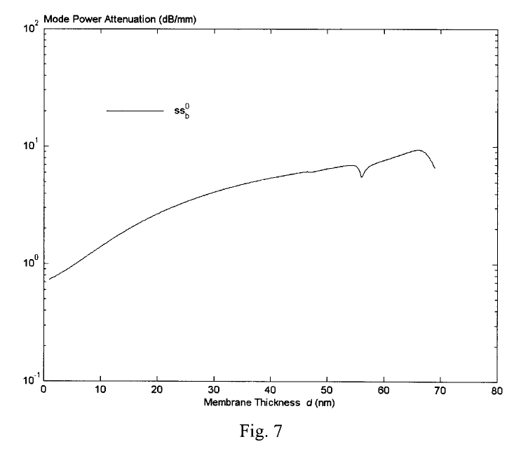

FIG. 7 gives the computed attenuation of the ss_{b}⁰ mode over the range of membrane thickness d, showing that the attenuation increases slightly with membrane thickness—indicating increasing confinement to the strip 12. The attenuation remains low over the range of thicknesses shown.

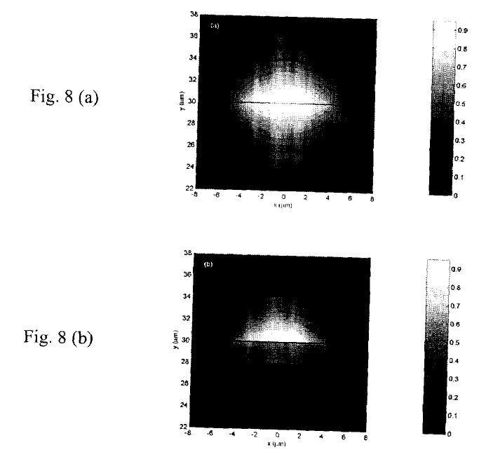

FIG. 8 gives the computed distribution of the normalized real part of the main transverse electric field component (Re{E_{y}}) of the ss_{b}⁰ mode over the waveguide cross-section for two specific waveguide geometries. Part (a) shows the distribution of Re{E_{y}} for the case w=8 μm, t=30 nm and d=1 nm, corresponding to the nominal situation where the membrane 14 is not optically invasive (i.e., effectively absent); the computed coupling loss to standard single mode fiber in this case was 1.54 dB. Part (b) shows the distribution of Re{E_{y}} for the case w=8 μm, t=30 nm and d=20 nm; the computed coupling loss to standard single mode fiber in this case was 1.06 dB.

Thus, when the free-space operating wavelength is set to 1550 nm, the membrane 14 is SiO₂, the strip is Au, and the environment is vacuum, dimensions of w=8 μm, t=30 nm and d=20 nm provide a preferred waveguide structure since the ss_{b}⁰ mode supported therein is well confined, has reasonably low loss and exhibits good coupling efficiency to standard single mode fiber. Also, the membrane 14 is thin enough to be optically not too invasive while being thick enough to be mechanically sound and provide adequate support.

### EXAMPLE 2

The free-space operating wavelength was set to 1310 nm, SiO₂ (ε_{r,2}=1.4468²) was selected as the material for the membrane 14, Au (ε_{r,3}=−86.08−j8.322) was selected as the material for the strip 12, and vacuum (ε_{r,1}=1) was selected for the environment E. The width w of the strip was set to 6 μm, its thickness t was set to 30 nm, and the thickness d of the membrane was varied from substantially 0 to about 55 nm for the purpose of illustrating its impact on the performance of the waveguide.

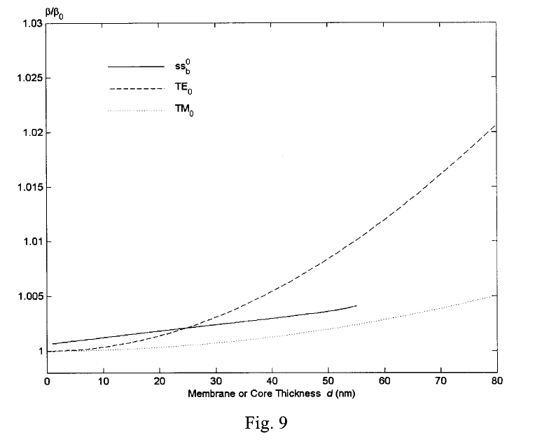

FIG. 9 gives the computed effective refractive index of the ss_{b}⁰ mode over the range of membrane thickness. The effective index of the TE₀ and TM₀ modes supported by the membrane 14 alone (i.e.: without the strip 12) was also plotted for reference.

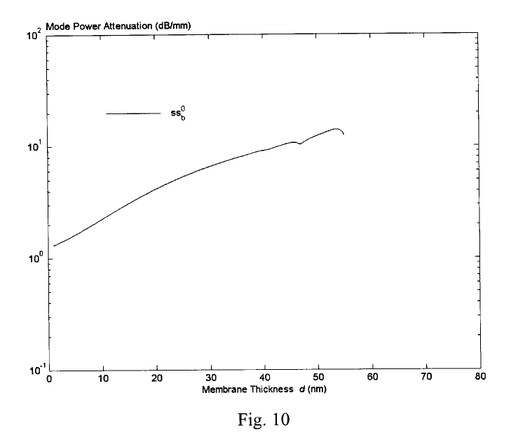

FIG. 10 gives the computed attenuation of the ss_{b}⁰ mode over the range of membrane thicknesses d, showing that the attenuation increases slightly with membrane thickness—indicating increasing confinement to the strip 12. The attenuation remains low over the range of membrane thicknesses shown.

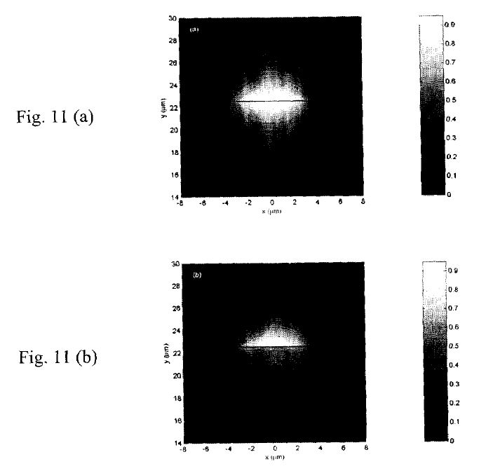

FIG. 11 gives the computed distribution of Re{E_{y}} over the waveguide cross-section for two specific waveguide geometries. Part (a) shows the distribution of Re{E_{y}} for the case w=6 μm, t=30 nm and d=1 nm, corresponding to the nominal situation where the membrane 14 is not optically invasive (i.e., effectively absent); the computed coupling loss to standard single mode fiber in this case was 0.59 dB. Part (b) shows the distribution of Re{E_{y}} for the case w=6 μm, t=30 nm and d=20 nm; the computed coupling loss to standard single mode fiber in this case was 0.49 dB.

Thus, when the free-space operating wavelength is set to 1310 nm, the membrane 14 is SiO₂, the strip 12 is Au, and the environment is vacuum, the dimensions w=6 μm, t=30 nm and d=20 nm provide a preferred embodiment of waveguide structure since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### EXAMPLE 3

The free-space operating wavelength was set to 1310 nm, SiO₂ (ε_{r,2}=1.4468²) was selected as the material of the membrane 14, Au (ε_{r,3}=−86.08−j8.322) was selected as the material of the strip 12, and water (ε_{r,1}=(1.3159−j1.639×10⁻⁵)²) was selected as the environment E. The width w of the strip 12 was set to 3 μm, its thickness/was set to 20 nm, and the thickness d of the membrane 14 was varied from substantially 0 to 100 nm for the purpose of illustrating its impact on the performance of the waveguide.

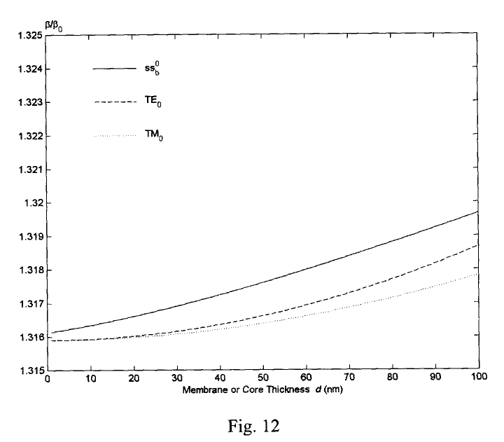

FIG. 12 gives the computed effective refractive index of the ss_{b}⁰ mode over the range of membrane thicknesses. The effective index of the TE₀ and TM₀ modes supported by the membrane 14 alone (i.e.: without the strip 12) was also plotted for reference.

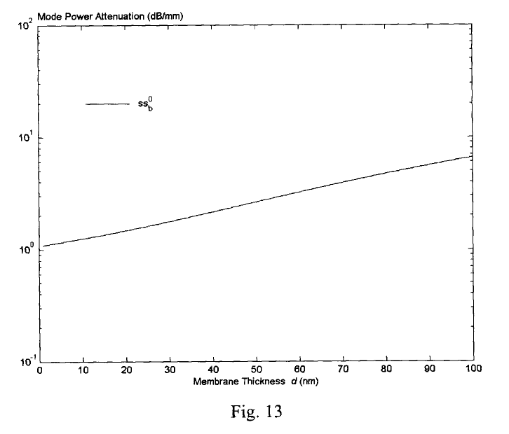

FIG. 13 gives the computed attenuation of the ss_{b}⁰ mode over the range of membrane thickness, showing that the attenuation increases slightly with membrane thickness—indicating increasing confinement to the strip 12. The attenuation remains low over the range of thickness d shown.

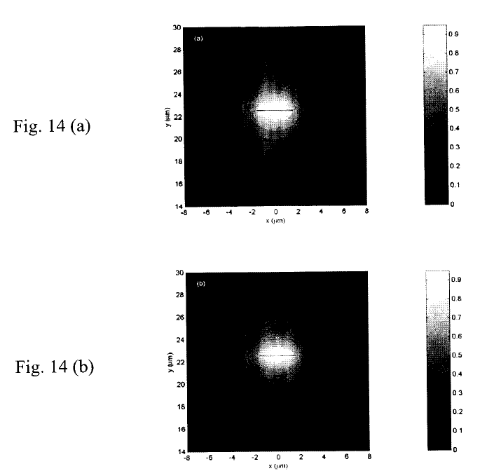

FIG. 14 gives the computed distribution of Re{E_{y}} over the waveguide cross-section for two specific waveguide geometries. Part (a) shows the distribution of Re{E_{y}} for the w=3 μm, t=20 nm and d=1 nm, corresponding to the nominal situation where the membrane 14 is not optically invasive (i.e., effectively absent); the computed coupling loss to standard single mode fiber in this case is 1.12 dB. Part (b) shows the distribution of Re{E_{y}} for the case w=3 μm, t=20 nm and d=20 nm; the computed coupling loss to standard single mode fiber in this case is 0.45 dB.

Thus, when the free-space operating wavelength is set to 1310 nm, the membrane to SiO₂, the strip is Au, and the environment is water, the dimensions w=3 μm, t=20 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### EXAMPLE 4

The free-space operating wavelength was set to 1310 nm, Si₃N₄ (ε_{r,2}=2²) was selected as the material for the membrane 14, Au (ε_{r,3}=−86.08−j8.322) was selected as the material of the strip 12, water (ε_{r,1}=(1.3159−j1.639×10⁻⁵)²) was selected for the environment E. The width w of the strip 12 was set to 6 μm, its thickness t was set to 25 nm, and the thickness d of the membrane 14 was varied from substantially 0 to about 40 nm for the purpose of illustrating its impact on the performance of the waveguide.

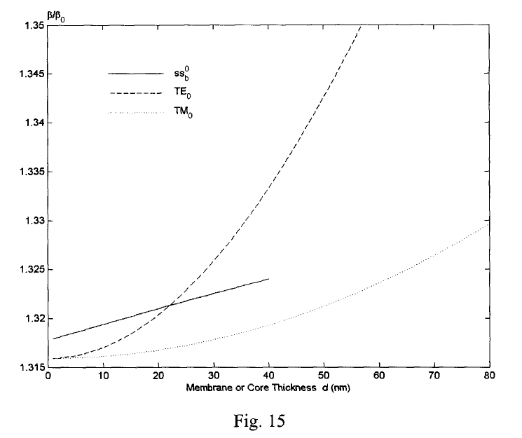

FIG. 15 gives the computed effective refractive index of the ss_{b}⁰ mode over the range of membrane thicknesses. The effective refractive index of the TE₀ and TM₀ modes supported by the membrane 14 alone (i.e.: without the strip) was also plotted for reference.

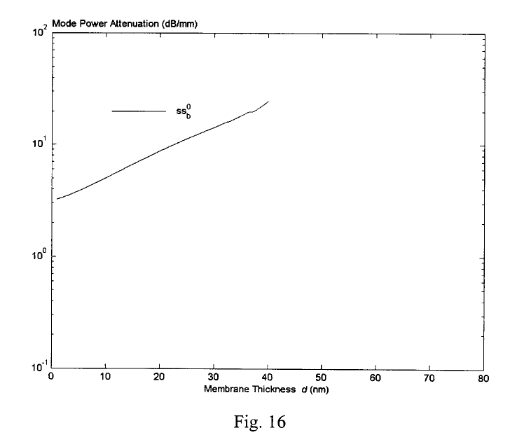

FIG. 16 gives the computed attenuation of the ss_{b}⁰ mode over the range of membrane thicknesses, showing that the attenuation increases slightly with membrane thickness—indicating increasing confinement to the metal film. The attenuation remains low over the range of thicknesses shown.

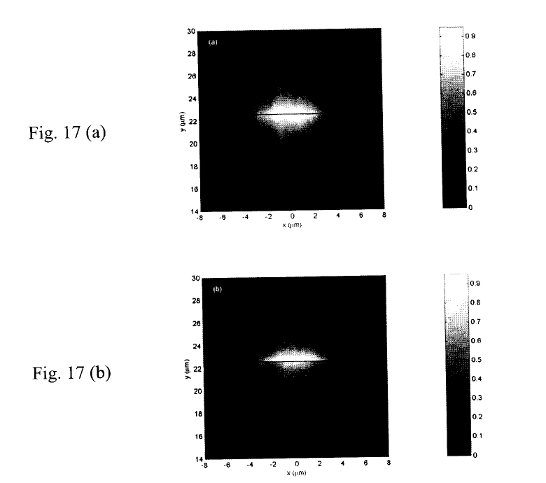

FIG. 17 gives the computed distribution of Re{E_{y}} over the waveguide cross-section for two specific waveguide geometries. Part (a) shows the distribution of Re{E_{y}} for the case w=6 μm, t=25 nm and d=1 nm, corresponding to the nominal situation where the membrane 14 is not optically invasive (i.e., effectively absent); the computed coupling loss to standard single mode fiber in this case was 0.36 dB. Part (b) shows the distribution of Re{E_{y}} for the case w=6 μm, t=25 nm and d=20 nm; the computed coupling loss to standard single mode fiber in this case was 1.11 dB.

Thus, when the free-space operating wavelength is set to 1310 nm, the membrane is Si₃N₄, the strip is Au, and the environment is water, the dimensions w=6 μm, t=25 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### EXAMPLE 5

The free-space operating wavelength was set to 632.8 nm, Si₃N₄ (ε_{r,2}=2.0211²) was selected as the material of the membrane 14, Au (ε_{r,3}=−11.7851−j1.2562) was selected as the material of the strip 12, and water (ε_{r,1}=(1.3313−j1.552×10⁻⁸)²) was selected as the environment E. The width w of the strip 12 was set to 2 μm, its thickness t was set to 17 nm, and the thickness d of the membrane 14 was varied from substantially 0 to about 40 nm for the purpose of illustrating its impact on the performance of the waveguide.

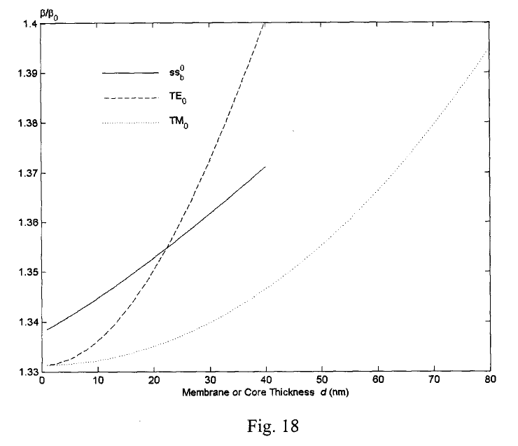

FIG. 18 gives the computed effective refractive index of the ss_{b}⁰ mode over the range of thicknesses of the membrane 14. The effective index of the TE₀ and TM₀ modes supported by the membrane 14 alone (i.e., without the strip 12) was also plotted for reference.

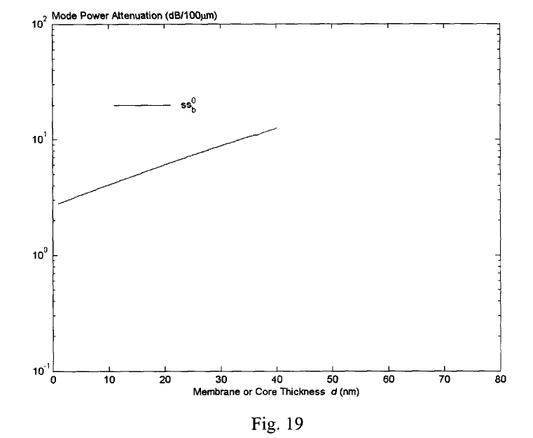

FIG. 19 gives the computed attenuation of the ss_{b}⁰ mode over the range of membrane thicknesses, showing that the attenuation increases slightly with membrane thickness—indicating increasing confinement to the strip 12. The attenuation remains low over the range of thicknesses d shown.

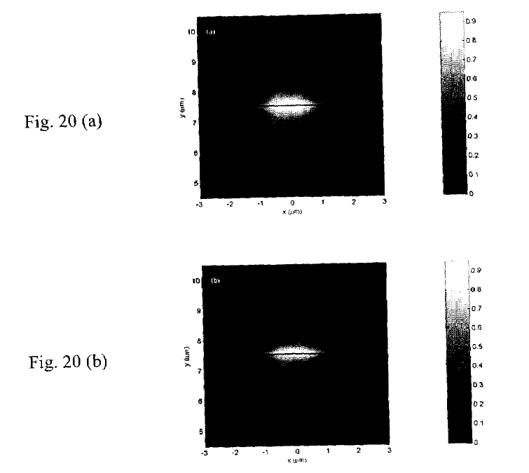

FIG. 20 gives the computed distribution of Re{E_{y}} over the waveguide cross-section for two specific waveguide geometries. Part (a) shows the distribution of Re{E_{y}} for the case w=2 μm, t=17 nm and d=1 nm, corresponding to the nominal situation where the membrane 14 is not optically invasive (i.e., effectively absent); the computed coupling loss to standard single mode fiber in this case was 1.57 dB. Part (b) shows the distribution of Re{E_{y}} for the case w=2 μm, t=17 nm and d=20 nm; the computed coupling loss to standard single mode fiber in this case was 3.32 dB.

Thus, when the free-space operating wavelength is set to 632.8 nm, the membrane 14 to Si₃N₄, the strip 12 to Au, and the environment to water, the dimensions w=2 μm, t=1 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### EXAMPLE 6

The free-space operating wavelength was set to 1310 nm, Si₃N₄ (ε_{r,2}=2²) was selected as the material for the membrane 14, Au (ε_{r,3}=−86.08−j8.322) was selected as the material of the strip 12, water (ε_{r,1}=(1.3159−j1.639×10⁻⁵)²) was selected for the environment E. The width w of the strip 12 was set to 5 μm, its thickness t was set to 25 nm, and the thickness d of the membrane 14 was varied from substantially 0 to about 30 nm for the purpose of illustrating its impact on the performance of the waveguide.

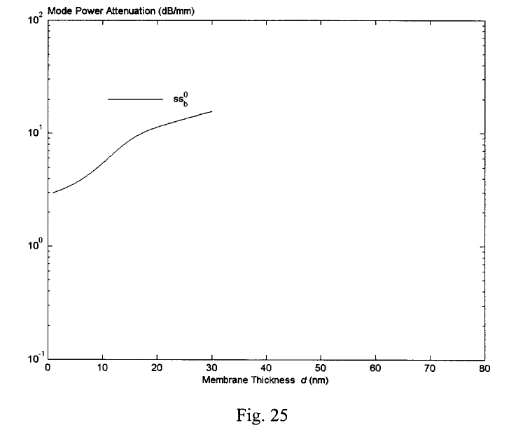

FIG. 24 gives the computed effective refractive index of the ss_{b}⁰ mode over the range of membrane thicknesses. The effective refractive index of the TE₀ and TM₀ modes supported by the membrane 14 alone (i.e.: without the strip) was also plotted for reference.

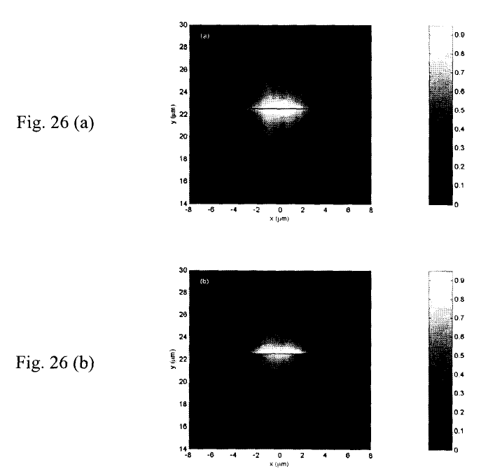

FIG. 25 gives the computed attenuation of the ss_{b}⁰ mode over the range of membrane thicknesses, showing that the attenuation increases slightly with membrane thickness—indicating increasing confinement to the metal film. The attenuation remains low over the range of thicknesses shown.

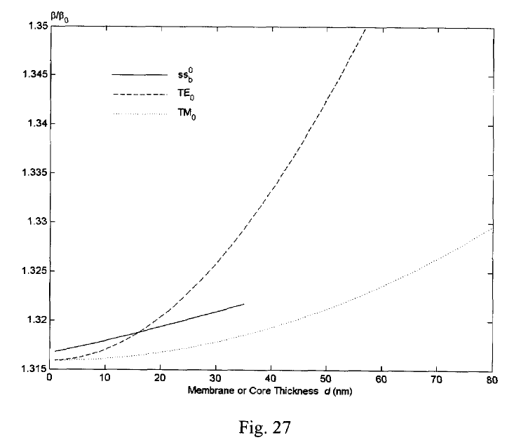

FIG. 26 gives the computed distribution of Re{E_{y}} over the waveguide cross-section for two specific waveguide geometries. Part (a) shows the distribution of Re{E_{y}} for the case w=5 μm, t=25 nm and d=1 nm, corresponding to the nominal situation where the membrane 14 is not optically invasive (i.e., effectively absent); the computed coupling loss to standard single mode fiber in this case was 0.33 dB. Part (b) shows the distribution of Re{E_{y}} for the case w=5 μm, t=25 nm and d=20 nm; the computed coupling loss to standard single mode fiber in this case was 1.11 dB.

Thus, when the free-space operating wavelength is set to 1310 nm, the membrane is Si₃N₄, the strip is Au, and the environment is water, the dimensions w=5 μm, t=25 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### EXAMPLE 7

The free-space operating wavelength was set to 1310 nm, Si₃N₄ (ε_{r,2}=2²) was selected as the material for the membrane 14, Au (ε_{r,3}=−86.08−j8.322) was selected as the material of the strip 12, water (ε_{r,1}=(1.3159−j1.639×10⁻⁵)²) was selected for the environment E. The width w of the strip 12 was set to 5 μm, its thickness t was set to 20 nm, and the thickness d of the membrane 14 was varied from substantially 0 to about 35 nm for the purpose of illustrating its impact on the performance of the waveguide.

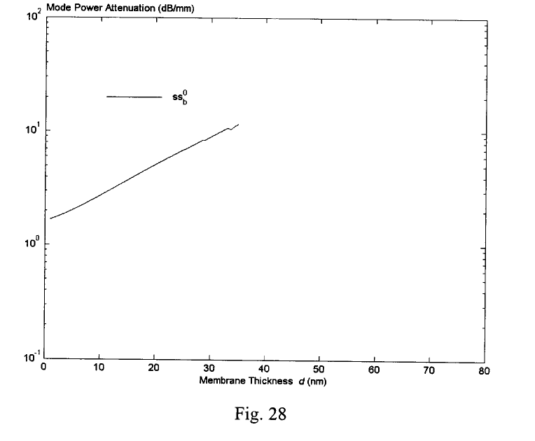

FIG. 27 gives the computed effective refractive index of the ss_{b}⁰ mode over the range of membrane thicknesses. The effective refractive index of the TE₀ and TM₀ modes supported by the membrane 14 alone (i.e.: without the strip) was also plotted for reference.

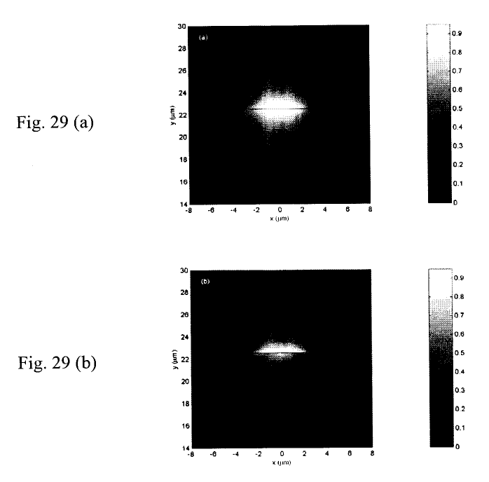

FIG. 28 gives the computed attenuation of the ss_{b}⁰ mode over the range of membrane thicknesses, showing that the attenuation increases slightly with membrane thickness—indicating increasing confinement to the metal film. The attenuation remains low over the range of thicknesses shown.

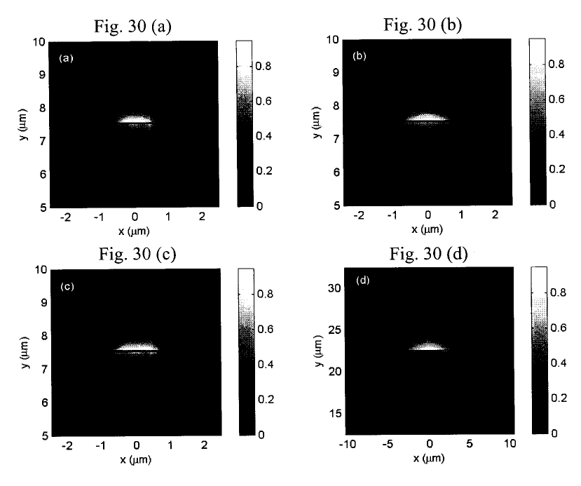

FIG. 29 gives the computed distribution of Re{E_{y}} over the waveguide cross-section for two specific waveguide geometries. Part (a) shows the distribution of Re{E_{y}} for the case w=5 μm, t=20 nm and d=1 nm, corresponding to the nominal situation where the membrane 14 is not optically invasive (i.e., effectively absent); the computed coupling loss to standard single mode fiber in this case was 0.29 dB. Part (b) shows the distribution of Re{E_{y}} for the case w=5 μm, t=20 nm and d=30 nm; the computed coupling loss to standard single mode fiber in this case was 1.09 dB.

Thus, when the free-space operating wavelength is set to 1310 nm, the membrane is Si₃N₄, the strip is Au, and the environment is water, the dimensions w=5 μm, t=20 nm and d=30 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

### EXAMPLE 8

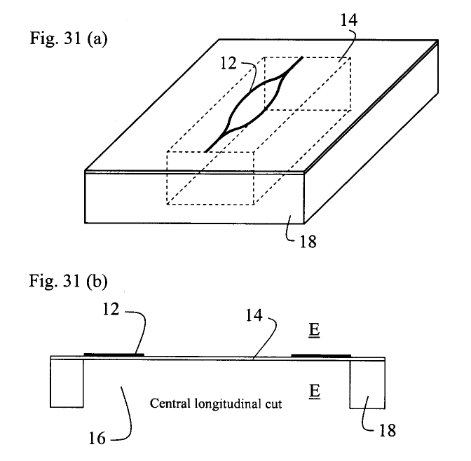

The free-space operating wavelength was set to 632.8 nm, Si₃N₄ (ε_{r,2}=2.0211²) was selected as the material of the membrane 14, Au (ε_{r,3}=−11.7851−j1.2562) was selected as the material of the strip 12, and vacuum (ε_{r,1}=1) was selected for the environment E. The width w of the strip 12 was set to 0.95 μm, its thickness t was set to 25 nm, and the thickness d of the membrane 14 was set to 20 nm. The computed effective refractive index of the ss_{b}⁰ mode was 1.00898, its attenuation was 4.39 dB/100 μm and its coupling loss to standard single mode fiber was 1.60 dB. For reference, the effective index of the TE₀ and TM₀ modes supported by the membrane 14 alone (i.e., without the strip 12) are 1.04412 and 1.00285, respectively. FIG. 30(a) gives the computed distribution of Re{E_{y}} over the waveguide cross-section.

Thus, when the free-space operating wavelength is set to 632.8 nm, the membrane 14 to Si₃N₄, the strip 12 to Au, and the environment to vacuum, the dimensions w=0.95 μm, t=25 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

Repeating this analysis for the case of water (ε_{r,1}=(1.3313−j1.552×10⁻⁸)²) as the environment E reveals that this structure remains a preferred embodiment for the same reasons.

### EXAMPLE 9

The free-space operating wavelength was set to 632.8 nm, Si₃N₄ (ε_{r,2}=2.0211²) was selected as the material of the membrane 14, Au (ε_{r,3}=−11.7851−j1.2562) was selected as the material of the strip 12, and vacuum (ε_{r,1}=1) was selected for the environment E. The width w of the strip 12 was set to 1.25 μm, its thickness t was set to 21 nm, and the thickness d of the membrane 14 was set to 20 nm. The computed effective refractive index of the ss_{b}⁰ mode was 1.00867, its attenuation was 3.03 dB/100 μm and its coupling loss to standard single mode fiber was 1.42 dB. For reference, the effective index of the TE₀ and TM₀ modes supported by the membrane 14 alone (i.e., without the strip 12) are 1.04412 and 1.00285, respectively. FIG. 30(b) gives the computed distribution of Re{E_{y}} over the waveguide cross-section.

Thus, when the free-space operating wavelength is set to 632.8 nm, the membrane 14 to Si₃N₄, the strip 12 to Au, and the environment to vacuum, the dimensions w=1.25 μm, t=21 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

Repeating this analysis for the case of water (ε_{r,1}=(1.3313−j1.552×10⁻⁸)²) as the environment E reveals that this structure remains a preferred embodiment for the same reasons.

### EXAMPLE 10

The free-space operating wavelength was set to 632.8 nm, Si₃N₄ (ε_{r,2}=2.0211²) was selected as the material of the membrane 14, Au (ε_{r,3}=−11.7851−j1.2562) was selected as the material of the strip 12, and vacuum (ε_{r,1}=1) was selected for the environment E. The width w of the strip 12 was set to 1.25 μm, its thickness t was set to 25 nm, and the thickness d of the membrane 14 was set to 20 nm. The computed effective refractive index of the ss_{b}⁰ mode was 1.01094, its attenuation was 4.60 dB/100 μm and its coupling loss to standard single mode fiber was 1.90 dB. For reference, the effective index of the TE₀ and TM₀ modes supported by the membrane 14 alone (i.e., without the strip 12) are 1.04412 and 1.00285, respectively. FIG. 30(c) gives the computed distribution of Re{E_{y}} over the waveguide cross-section.

Thus, when the free-space operating wavelength is set to 632.8 nm, the membrane 14 to Si₃N₄, the strip 12 to Au, and the environment to vacuum, the dimensions w=1.25 μm, t=25 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

Repeating this analysis for the case of water (ε_{r,1}=(1.3313−j1.552×10⁻⁸)²) as the environment E reveals that this structure remains a preferred embodiment for the same reasons.

### EXAMPLE 11

The free-space operating wavelength was set to 1310 nm, (ε_{r,2}=2²) was selected as the material for the membrane 14, Au (ε_{r,3}=−86.08−j8.322) was selected as the material of the strip 12, and vacuum (ε_{r,1}=1) was selected for the environment E. The width w of the strip 12 was set to 5 μm, its thickness t was set to 25 nm, and the thickness d of the membrane 14 was set to 20 nm. The computed effective refractive index of the ss_{b}⁰ mode was 1.00169, its attenuation was 3.78 dB/mm and its coupling loss to standard single mode fiber was 0.58 dB. For reference, the effective index of the TE₀ and TM₀ modes supported by the membrane 14 alone (i.e., without the strip 12) are 1.01021 and 1.00065, respectively. FIG. 30(d) gives the computed distribution of Re{E_{y}} over the waveguide cross-section.

Thus, when the free-space operating wavelength is set to 1310 nm, the membrane 14 to Si₃N₄, the strip 12 to Au, and the environment to vacuum, the dimensions w=5 μm, t=25 nm and d=20 nm provide a waveguide structure that is a preferred embodiment since the ss_{b}⁰ mode supported therein is well confined, has reasonably low loss and exhibits good coupling efficiency to standard single mode fiber, using a membrane 14 that is thin enough to be optically not too invasive while being thick enough to be mechanically sound and provide adequate support.

Repeating this analysis for the case of water (ε_{r,1}=(1.3159−j1.639×10⁻⁵)²) as the environment E reveals that this structure remains a preferred embodiment for the same reasons (see Example 6).

### Adhesion Layer:

In the fabrication of waveguide structures, it might be desirable to use a thin adhesion layer, placed between strip 12 and membrane 14 in FIG. 4, in order to promote the adhesion of the strip 12 to the membrane 14. This would be particularly desirable when the strip material is, for example, Au and the membrane material is, for example, one of Si₃N₄, SiO₂ or SiON. In such cases, a suitable adhesion material is one of Cr, Ti or Mo, the adhesion layer would have the same width was the strip, and the adhesion layer would be 2 to 5 nm thick. It should be appreciated that this adhesion layer is not to be confused with the adlayer, where provided.

### EXAMPLE 12

In the case of the preferred embodiment and conditions described under Example 6 (d=20 nm), it was computed that changing the strip from pure Au to a metal stack comprised of 3 nm of Cr (on Si₃N₄) followed by 22 nm of Au (on Cr) for a total stack thickness of 25 nm leaves the ss_{b}⁰ mode virtually unchanged, decreasing its attenuation by about 2%. Repeating this analysis for the case of Ti as the adhesion material yields substantially the same result.

### EXAMPLE 13

In the case of the preferred embodiment and conditions described under Example 7 (d=30 nm), it was computed that changing the strip from pure Au to a metal stack comprised of 3 nm of Cr (on Si₃N₄ followed by 17 nm of Au (on Cr) for a total thickness of 20 nm leaves the ss_{b}⁰ mode virtually unchanged, increasing its attenuation by about 30%. Repeating this analysis for the case of Ti as the adhesion material yields substantially the same result.

### Mechanical Support Means

The mechanical supports 18A and 18B (FIGS. 3 and 4) and 18L′, 18L″, 18R′; and 18R″ (FIG. 5) for supporting membrane 14, and the membrane 14 itself, may be fabricated on a Si wafer using standard lithography, deposition, and etching processes. Such processes are well-known to persons skilled in the fabrication arts and so will not be described in detail herein.

To ensure mechanical stability, the bottom surface of substrate 18 (FIGS. 3 and 4) or 18′ (FIG. 5) could be bonded to additional support means, for example a second Si wafer.

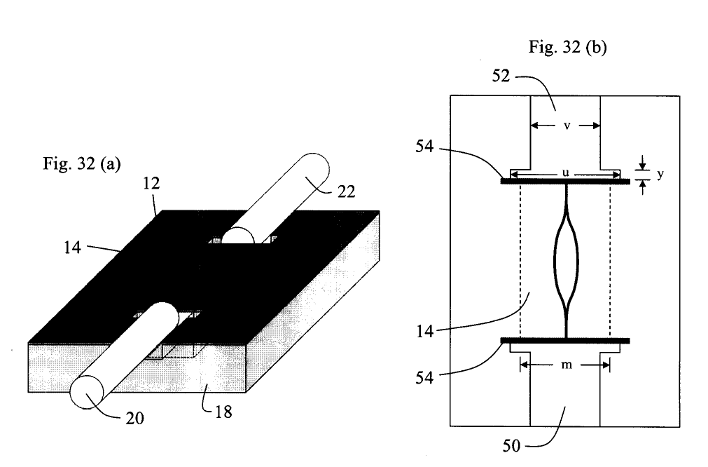

An alternative membrane waveguide structure is shown in isometric view in FIG. 31 (a), and in cross-sectional view taken along the longitudinal centre of the structure in FIG. 31 (b). In this embodiment, the membrane 14 is released from the substrate 18 by etching (for example) through the substrate material 18 to define cavity 16 shown in outline via the dashed lines in FIG. 31 (a) and in cross-sectional view in FIG. 31 (b). The cavity 16 is open at the bottom so that, in the region of the waveguide structure, the environment E is partitioned by the membrane 14 into optically semi-infinite portions, each portion extending away from the membrane 14 in the direction perpendicular to the plane of the membrane. The interior of the cavity 16 is in communication with the portion of the environment E at the opposite surface of the membrane 14, i.e., which carries the strip 12. Thus, the environment E is substantially the same each side of the strip 12 and membrane 14. In this alternative structure, the membrane is clamped all around and so is robust mechanically. A variant of this structure (not shown) has holes 36 in the membrane, as in FIG. 22, and a closed cavity 16 achieved by, say, bonding another substrate to the bottom surface of substrate 18.

The membrane in any of the embodiments need not have a rectangular shape when observed in plan view as suggested in FIGS. 3 and 31. Oval-like, elliptical-like or irregular shapes are also acceptable, as long as the width of the membrane m is always large enough to ensure that the substrate 18 remains optically non-invasive.

### Input and Output Means

As described hereinbefore, with reference to FIGS. 1, 2 and 4, appropriately designed waveguide structures embodying the present invention can be coupled efficiently with conventional dielectric waveguides 20, 22, say optical fibers, butt-coupled to the input and output ends of the waveguide structure. In order to achieve a high input coupling efficiency, the input waveguide 20 should be single-mode at the operating free-space wavelength, and its mode polarization-aligned and overlapping very well with the ss_{b}⁰ mode of the waveguide structure. Preferably, the input waveguide 20 is a polarization-maintaining single-mode fiber. The output waveguide 22 can be a polarization-maintaining single-mode fiber, a multimode fiber, or preferably, a standard single-mode fiber.

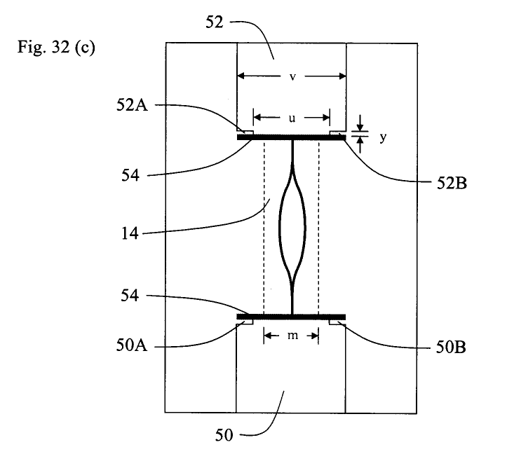

A similar waveguide structure is shown in isometric view in FIG. 32 (a) and in top view in FIG. 32 (b), where the input and output fibers 20 and 22 are placed within input and output trenches 50 and 52 etched through the top surface of the structure into the substrate 18. The width v of the trenches is selected to be slightly larger than the diameter of the fibers and their depth is set to half of this size. The dimensions of the fabricated trenches are accurate since the trench widths are controlled lithographically and their depths and verticality through the etching process, so they can be used to precisely align the fibers to the waveguide structure. If desired, the trenches can be widened to a width u over a length y of a few microns near the membrane of width m. This could be helpful from the fabrication standpoint.

FIG. 32 (c) shows a case where the membrane width m is less than the trench width v, consequently, the width u can be set greater than m but less than v. Advantageously, portions 50A, 50B, 52A and 52B are thus defined, serving to stop the input and output fibers 20 and 22 (not shown) from contacting the membrane 14. Optionally, strength members 54 can be added, spanning the width of the unattached ends of the membrane 14, if additional strength is desired. The strength members are a few microns wide and a few microns thick and could be comprised of any of the materials identified for the membrane. Such strength members would not be too invasive optically.

It is also envisaged, however, that light could be coupled into and/or out of the waveguide structure via the top surface, for example by means of a prism coupler, or by means of a grating or scattering means (or many scattering means) patterned on or within a portion of the strip 12, as will be described in more detail hereinafter.

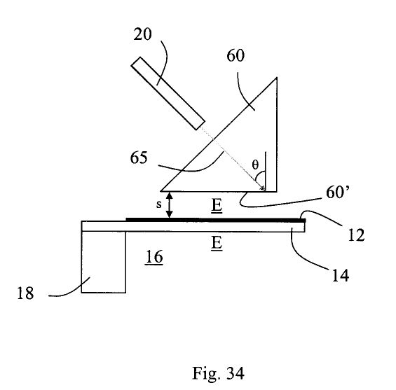

FIG. 33(a) shows, for example, an arrangement of two prism couplers 60 and 62 with input and output fibers 20 and 22 used to interface with the waveguide structure via the top surface. The arrangement is shown in frontal view in FIG. 33 (b) and as a partial longitudinal cut through the centre of the input fiber, input prism and waveguide structure in FIG. 34. As shown in FIG. 34, the input fiber 20 is aligned such that the p-polarized input light beam 65 is incident onto the bottom surface 60′ of input prism 60 at an angle of incidence of θ and near the right angle corner of the prism. The prism is spaced a distance s from the strip 12 of the waveguide structure.

The spacing s and the angle of incidence 9 needed for optimum coupling between the incident p-polarized beam 65 and the ss_{b}⁰ mode supported by the waveguide structure are readily determined via computation using a plane wave model given the operating free space wavelength, the materials chosen for the strip 12 and the membrane 14, and the chosen environment E. A lens, or a system of lenses, could be inserted between the fiber 20 and the prism 60 in order to collimate, focus or otherwise shape the incident beam 65.

The output prism 62 and output fiber 22 are arranged in an identical but reversed (or mirrored) manner to the input, as suggested in FIG. 33 (a), and a lens or a system of lenses could likewise be inserted between the fiber 22 and the prism 62. The arrangement at the input and output is such that the input and output beams couple with the ss_{b}⁰ mode at a location along the membrane waveguide structure where the substrate 18 is optically non-invasive, as suggested for the input in FIG. 34. FIGS. 33(c) and (d) show optional rails 70 and 72, added to the waveguide structure in order to facilitate accurate spacing of the prisms relative to the strip 12. The rails 70, 72 have the precise thickness 5 required to achieve the optimal optical coupling. Alternatively, small pedestals of thickness s could be added to the bottom surfaces of the prisms 60 and 62 for the same purpose. Any of the materials listed for the membrane and for the strip, could be used for the rails 70 and 72 and for said pedestals. Alternatively, any other convenient material can be used or any micro-object having the correct size can be used.

### EXAMPLE 14

In the case of the preferred embodiment and conditions described under Example 6 (d=20 nm), it was computed, using a plane wave model, that almost 100% coupling would occur between the p-polarised incident wave and the ss_{b}⁰ mode using a prism comprised of BK7 (n=1.5036 at 1310 nm) spaced a distance 5 of 2 to 4 μm away from the Au strip and with the beam incident at an angle θ of about 61.5 to 61.7 Deg. Particularly good values are s=3 μm and θ=61.58 Deg.

### EXAMPLE 15

In the case of the preferred embodiment and conditions described under Example 11 (with vacuum as the environment), it was computed, using a plane wave model, that almost 100% coupling would occur between the p-polarised incident wave and the ss_{b}⁰ mode using a prism comprised of BK7 (n=1.5036 at 1310 nm) spaced a distance s of 2 to 7 μm away from the Au strip and with the beam incident at an angle θ of about 41.7 to 41.9 Deg. Particularly good values are s=4.2 μm and θ=41.85 Deg.

### EXAMPLE 16

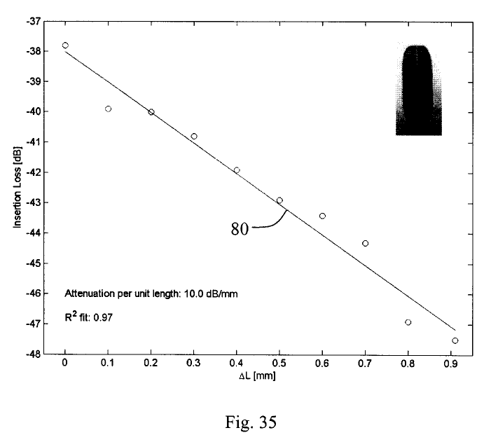

A straight waveguide structure corresponding to the preferred embodiment described under Examples 6 (d=20 nm) and 12 (except using 2 nm of Cr followed by 23 nm of Au), and implemented as the clamped membrane shown in FIG. 31, was fabricated using Si as the substrate 18. A microscope image of a typical fabricated structure is shown as the inset to FIG. 35. The waveguide was operated under the same conditions as those described under Example 6, by submerging the structure within a basin holding the liquid comprising the environment E. The ss_{b}⁰ mode was successfully excited along this structure using an input prism and an input single mode fiber, in the arrangement depicted in FIG. 33(a) and FIG. 34, and according to Example 14 with s˜3 μm and θ˜61.58 Deg. In keeping with the well-known cut-back technique, the fiber to fiber insertion loss was measured for various lengths of waveguide, and the measurements are shown as the open circles on the linear plot in FIG. 35 (ΔL corresponds to the distance between a measurement point and the first measurement). The best fitting (least squares) linear model 80 is also plotted for reference. The data and model have an R² correlation of 0.97 (R is the Pearson product-moment correlation coefficient). The slope of the linear model yields the measured attenuation, which is 10 dB/mm, in very good agreement with theory as can be deduced by comparison with FIG. 25 for d=20 nm.

### EXAMPLE 17

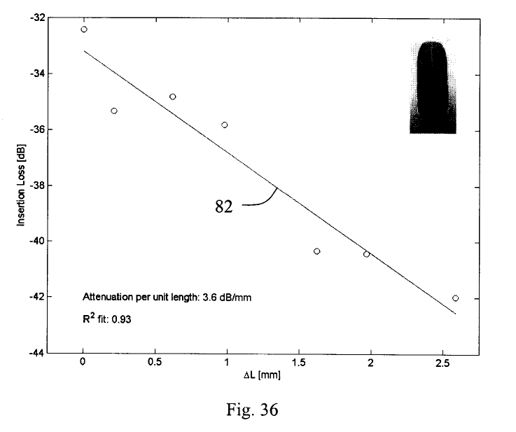

A straight waveguide structure corresponding to the preferred embodiment described under Example 11 (with air as the environment), and Example 12 (except using 2 nm of Cr followed by 23 nm of Au) and implemented as the clamped membrane shown in FIG. 31, was fabricated using Si as the substrate 18. A microscope image of a typical fabricated structure is shown as the inset to FIG. 36. The waveguide was operated under conditions similar to those described under Example 11, by allowing the ambient air (ε_{r,1}˜1) as the environment E to surround the waveguide structure. The ss_{b}⁰ mode was successfully excited along this structure using an input prism and an input single mode fiber, in the arrangement depicted in FIG. 33(a) and FIG. 34, and according to Example 15 with s˜4.2 μm and θ˜41.85 Deg.

In keeping with the well-known cut-back technique, the fiber to fiber insertion loss was measured for various lengths of waveguide, and the measurements are shown as the open circles on the linear plot in FIG. 36 (ΔL corresponds to the distance between a measurement point and the first measurement). The best fitting (least squares) linear model 82 is also plotted for reference. The data and model have an R² correlation of 0.93 (R is the Pearson product-moment correlation coefficient). The slope of the linear model yields the measured attenuation, which is 3.6 dB/mm, in very good agreement with theory as can be deduced by comparison with the computation given under Example 11.

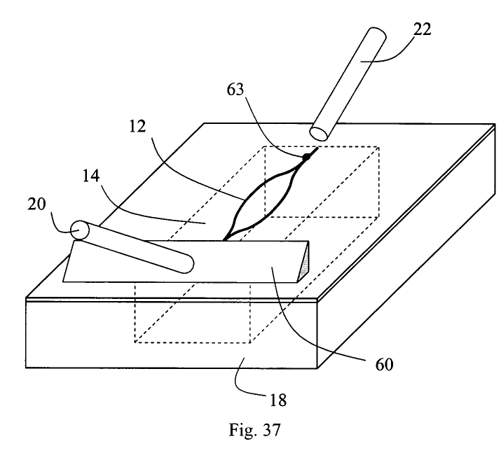

FIG. 37 gives an example of the coupling means comprising a scattering means 63 defined lithographically on top of the strip 12, and an optical output fiber 22 used to collect at least a portion of the scattered light. The scattering means 63 and fiber 22 are convenient for monitoring the level of power at a particular location along the waveguide structure. The scattering means 63 may take the form of a parallelepiped, as shown, or various other shapes, such as a cylindrical or triangular rod. The scattering means 63 may or may not be centered on the strip 12. An apex of the center might also be aligned with the central axis of the strip. The thickness of the centre is selected such that its cross-sectional area overlaps with a good part of the mode, good values for its area being about 5 to 50% of the mode area. Thus, a thickness in the range of 0.1 to 3 μm is suitable for centers used with the preferred embodiments described under Examples 1 to 11. Any of the materials listed for the membrane or the strip may be used. Alternatively, any other convenient material can be used or any micro-object having the appropriate size can be used. Preferably the material is a metal. The output optical fiber 22 can be a polarization-maintaining single-mode fiber, a multimode fiber, a standard single-mode fiber, or a high numerical aperture fiber.

In FIG. 37, the scattering means 63 is shown upon the central portion of membrane 14 that extends across the mouth of cavity 16. It should be appreciated, however, that the scattering means 63 could be positioned on a margin portion of the membrane 14 overlying the substrate 18, aligned with and close to the distal end of strip 12. The output waveguide 22 would be displaced outwards as required to ensure collection of the scattered light.

### EXAMPLE 18

Such a scattering means in the form of a parallelepiped 1.25 μm thick, 4 μm wide by 4 μm long was deposited onto the strip 12 of a waveguide structure similar to that described under Example 16, but with the scattering means 63 positioned on the margin of membrane 14 and the output waveguide 22 moved outwards. The waveguide was operated under the same conditions as in Example 16, with the excitation provided in like manner by an input prism coupler 60 and an input fiber 20. Light in the ss_{b}⁰ mode propagating along the waveguide was observed to scatter from the scattering means 63. The scattered light was collected first by an infrared camera through an optical microscope, then by a multimode fiber aligned perpendicularly to the scattering means 63 at a distance of about 15 μm, and finally by a single-mode fiber also aligned perpendicularly to the scattering means at a distance of about 15 μm. The optical output powers collected were sufficiently high to be useful in a monitoring function.

A chain of scattering means can be arranged to form an input or output grating coupler, which when excited with p-polarised light at the appropriate angle of incidence results in efficient energy transfer with the ss_{b}⁰ mode of the waveguide.

It should be appreciated that, when it is stated that the membrane 14 must be “not too invasive optically”, the level of “invasiveness” that can be tolerated or will, in fact, be desired will depend upon the particular application. In some cases, the degree of optical invasiveness should be minimal, i.e., the membrane 14 should have minimal effect upon the propagation of the plasmon-polariton wave. In other cases, however, for example surface sensors, a degree of invasiveness is, in fact, beneficial, as will be explained hereafter.

### Surface Sensor:

Observing the mode field distributions shown in FIGS. 8, 11, 14, 17, 20, 26, 29 and 30, computed in the case of the Examples 1-11, reveals that the presence of the membrane 14 perturbs the mode such that it becomes more tightly confined to the strip 12 and that its fields become localized to its top surface (i.e.: to the surface of the strip not in contact with the membrane 14 but rather in contact with the environment E). Consider Example 6, for instance, and compare FIG. 26(a) with FIG. 26(b), which show the computed distribution of Re{E_{y}} over the waveguide cross-section for the cases d=1 nm and d=20 nm, respectively: FIG. 26(a), which corresponds to the nominal situation where the membrane 14 is effectively optically absent, shows the mode field (Re{E_{y}}) symmetrically distributed over the waveguide cross-section; FIG. 26(b), which corresponds to the situation where the membrane 14 is sufficiently thick to perturb the mode, shows the aforementioned localization and increased confinement compared to FIG. 26(a).

The increased confinement and localization of the mode fields to the top surface of the strip is beneficial to embodiments of the invention adapted for use in sensing applications and which have a thin layer adhered to this surface (e.g.: an adlayer), which changes in response to changes in the environment E itself or to changes in the concentration of a species (i.e.: the analyte) distributed within the environment. The adlayer could, for example, comprise a receptor molecule that is chemically specific to a particular analyte, or it might comprise a material that is chemically sensitive (or reactive) to a particular gas or liquid. Biosensors could be enabled using, for example, antibodies immobilized on the surface and selected to bind specifically to a target antigen or body (e.g., analyte) distributed within an aqueous environment E.

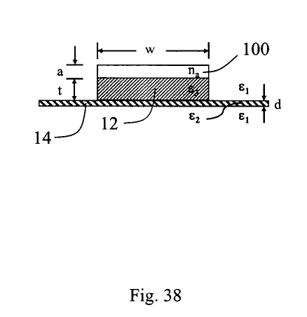

Hence, it is of interest to understand how changes in an adlayer located along the top surface of the strip 12 might confer changes to the ss_{b}⁰ mode propagating along the waveguide. In order to gain this understanding, a simple model 100 for the adlayer was adopted, as shown in FIG. 38. The adlayer model 100 is comprised of a dielectric region of refractive index n_{α}, of thickness α, and of the same width was the strip 12. Using computer modeling techniques, as described above for Examples 1-11, waveguide structures were analyzed with the adlayer shown in FIG. 38, and the sensitivity of the effective index n_{eff}=β/β₀ of the ss_{b}⁰ mode to changes in the thickness α of the adlayer, defined as ∂n_{eff}/∂α, was computed.

### EXAMPLE 19

The free-space operating wavelength was set to 1310 nm, Si₃N₄ (ε_{r,2}=2²) was selected as the material for the membrane 14, Au (ε_{r,3}=−86.08−j8.322) was selected as the material of the strip 12, water (ε_{r,1}=(1.3159−j1.639×10⁻⁵)²) was selected for the environment E, and an adlayer model typical of biological materials was selected (n_{α}=1.5, α=3 nm). The width w of the strip 12 was set to infinity and its thickness t was varied over the range 10≦t≦60 nm, while the thickness d of the membrane 14 was varied over the range 1≦d≦40 nm.

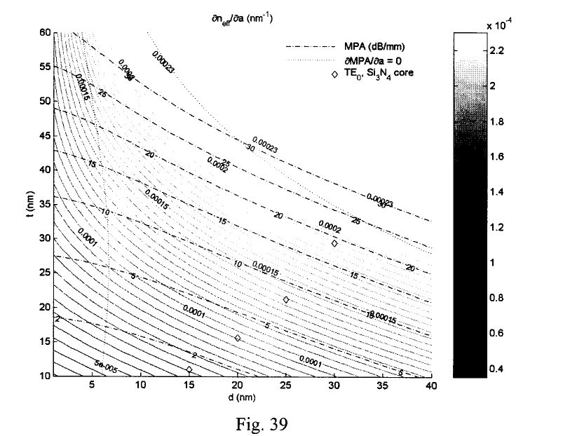

FIG. 39 gives the computed sensitivity ∂n_{eff}/∂α in nm⁻¹ of the ss_{b}⁰ mode over these ranges of strip and membrane thickness t and d. The computed sensitivities are plotted as solid gray-scaled constant-valued contours. The associated mode power attenuation (MPA) is also plotted in dB/mm for reference as the labeled dash-dot constant-valued contours. The effective refractive index of the TE₀ mode supported by the membrane 14 alone (i.e.: without the strip) is added as diamonds for a few thicknesses d. The associated mode power attenuation null sensitivity ∂MPA/∂α=0 is plotted for reference as the dotted constant-valued contour. The waveguide attenuation does not change with small changes in a for thicknesses (t, d) on this contour. In fact for dimensions everywhere inside of the region delimited by the contour, the attenuation sensitivity ∂MPA/∂α is very low.

Based on this plot, it is recognized that the ratio of effective index sensitivity to mode power attenuation (∂n_{eff}/∂α)/MPA is greatest in the region where the strip and membrane are thinnest. Hence preferred embodiments of this example will have/and d less than about 40 nm, leading to efficient operation. The results plotted in FIG. 39 do not change very much with strip width w, as long as it remains greater than about 5 μm.

### EXAMPLE 20

The free-space operating wavelength was set to 632.8 nm, Si₃N₄ (ε_{r,2}=2.0211²) was selected as the material of the membrane 14, Au (ε_{r,3}=−11.7851−j1.2562) was selected as the material of the strip 12, and water (ε_{r,1}=(1.3313−j1.552×10⁻⁸)²) was selected as the environment E, and an adlayer model typical of biological materials was selected (n_{α}=1.5, α=3 nm). The width w of the strip 12 was set to infinity and its thickness t was varied over the range 10≦t≦60 nm, while the thickness d of the membrane 14 was varied over the range 1≦d≦60 nm.

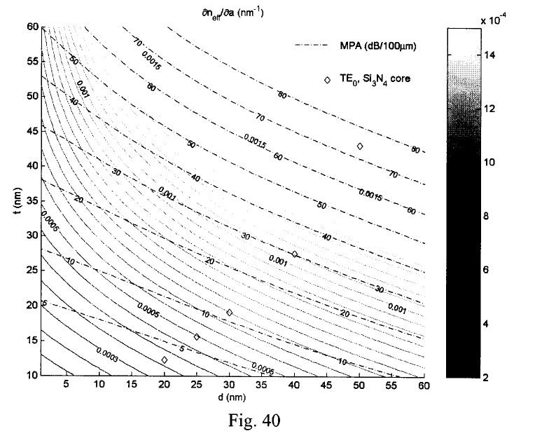

FIG. 40 gives the computed sensitivity ∂n_{eff}/∂α in nm⁻¹ of the ss_{b}⁰ mode over these ranges of strip and membrane thickness t and d. The computed sensitivities are plotted as solid gray-scaled constant-valued contours. The associated mode power attenuation (MPA) is also plotted in dB/100 μm for reference as the labeled dash-dot constant-valued contours. The effective refractive index of the TE₀ mode supported by the membrane 14 alone (i.e.: without the strip) is added as diamonds for a few thicknesses d. The waveguide attenuation does not change very much with small changes in α over the ranges of thicknesses (t, d) considered.

Based on this plot, it is recognized that the ratio of effective index sensitivity to mode power attenuation (∂n_{eff}/∂α)/MPA is greatest in the region where the strip and membrane are thinnest. Hence preferred embodiments of this example will have t and d less than about 40 nm, leading to efficient operation. The results plotted in FIG. 40 do not change very much with strip width w, as long as it remains greater than about 2 μm.

In light of the foregoing discussion and based on the results given under Examples 19 and 20, it is noted that Examples 1 to 11 are preferred waveguide embodiments for surface sensing since the structures exhibit a high surface sensitivity (∂n_{eff}/∂α) combined with a low mode power attenuation.

The sensitivity of the ss_{b}⁰ mode to changes in the refractive index n_{α} of the adlayer ∂n_{eff}/∂n_{α} was computed in a similar manner but using a thicker adlayer (α=100 nm) leading to the same conclusion that smaller values of t and d provide a better ratio of (∂n_{eff}/∂n_{α})/MPA and hence more efficient operation.

The change in the effective index of the ss_{b}⁰ mode Δn_{eff} due to the presence of an adlayer of thickness αₜ is written Δn_{eff}=αₜ∂n_{eff}/∂α. This change in effective index Δn_{eff} leads to a change in the insertion phase of the waveguide which can be detected by combining its output mode field with that emerging from an identical waveguide that is used as a reference and is made to not undergo a phase shift, and detecting the power of the resulting combination. A structure that is convenient for achieving this is the Mach-Zehnder interferometer, well-known from the art of conventional integrated optics. Also, a Mach-Zehnder interferometer implemented using a plasmon-polariton waveguide structure is disclosed in U.S. Pat. Nos. 6,614,960 and 6,442,321 supra.

### EXAMPLE 21

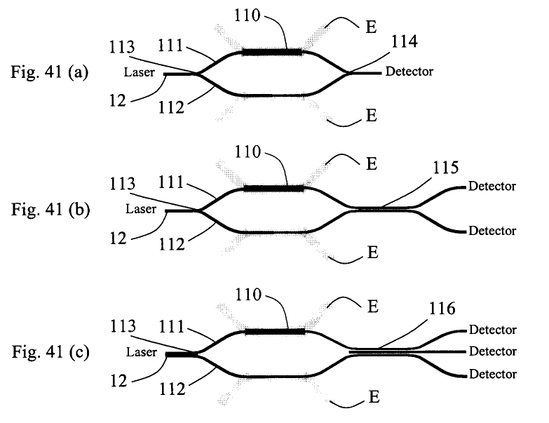

FIG. 41(a) shows schematically a Mach-Zehnder interferometer created from a strip 12, where the input strip is the input of first Y-junction splitter 113 leading to two branches 111 and 112, which are then combined into one output strip 12 using a Y-junction combiner 114. A laser (or other suitable light source) is coupled to the input strip 12 and an optical detector (not shown) is coupled to the output strip 12. Each branch of the interferometer is enclosed in its own channel (not shown) used to confine and guide the environment E. An advantage of this arrangement is that each branches 111 and 112 can be addressed independently by the environment E. One of the branches, specifically the sensing branch 111, is functionalized by coating the top surface of its strip 12 with an appropriate receptor layer or chemistry 110 selected to selectively capture the target analyte, while the other branch, the reference branch 112, is either left unfunctionalized (as shown) or is blocked by coating the top surface of its strip 12 with a blocking layer or chemistry. The same environment E carrying analyte is then made to flow over both of the branches 111 and 112. Hence, the sensing branch 111 undergoes a change in insertion phase as analyte binds while the reference branch 112 maintains a constant insertion phase. The difference between the insertion phase of the sensing branch 111 and the insertion phase of the reference branch 112 is termed the phase difference; clearly, the phase difference changes as analyte binds to the sensing branch 111.

The Y-junction combiner 114 combines the optical fields emerging from the sensing branch 111 and reference branch 112 into one output thus converting changes in phase difference to changes in intensity as captured by the detector (not shown). Advantageously, if the reference branch 112 is of the same length as the sensing branch 111 and both are of identical design, then the reference branch 112 used in this manner compensates substantially for thermal and strain variations along the device, and for changes in the bulk index of the environment E caused by thermal or compositional changes, since these effects occur substantially identically along both the sensing branch 111 and reference branch 112 due to their physical proximity; i.e.: these perturbations change the insertion phase of both branches 111 and 112 substantially identically. The reference branch 112 also compensates substantially for non-specific bindings which occur substantially identically along both branches 111 and 112. In order to obtain a unity visibility factor for the interferometer (i.e.: the greatest fringe contrast), the Y-junction splitter 113 and combiner 114 should be designed for an equal power split and the attenuation and length of the sensing branch 111 should be identical to those of the reference branch. A reference optical output signal could be added by incorporating either a scattering means 63 (see FIG. 37) in front of the input Y-junction splitter 113, or by introducing a coupler at the same location. A reference signal is advantageous in that source fluctuations can be substantially eliminated from the measured signal by the ratio of the measured to the reference power.

The sensing branch 111 and reference branch 112 are functionalized and blocked, respectively, using known techniques and known chemistries. For instance, the sensing branch can be functionalized by dispending droplets of solution comprising the desired chemistry using microspotting and/or masking techniques. The reference branch 112 can be blocked (if desired) by applying a blocking chemistry using the same techniques.

### EXAMPLE 22

FIG. 41 (b) shows a schematic of a Mach-Zehnder interferometer similar to that of FIG. 41 (a) except that the Y-junction combiner 114 is replaced with a dual output coupler 115. A particularly good design choice for the coupler 115 is a 3 dB coupler, since in this case, the two output powers are complementary and their sum remains constant as a function of the phase difference as long as the adlayer is non-absorbing. This confers additional advantages over the single output version shown in FIG. 41 (a) in that source and input coupling fluctuations can be rejected from the measurement by referencing (i.e.: forming the ratio of) one of the output powers to the sum of both or by referencing their difference to their sum.

### EXAMPLE 23

FIG. 41 (c) shows a schematic of a Mach-Zehnder interferometer similar to that of FIG. 41 (b) except that the dual output coupler 115 is replaced with a triple output coupler 116. A particularly good design choice for the coupler 116 is one where the responses of the three output powers versus the phase difference are shifted by 120° with respect to each other. In this case, the sum of the three output powers remains constant as a function of the phase difference as long as the adlayer is non-absorbing. Hence all three output powers are monitored independently, each referenced to the sum of all three, thus conferring additional advantages over the dual output version shown in FIG. 41(b) in that sensitivity fading and directional ambiguity of the Mach-Zehnder interferometer response are substantially mitigated.

### EXAMPLE 24

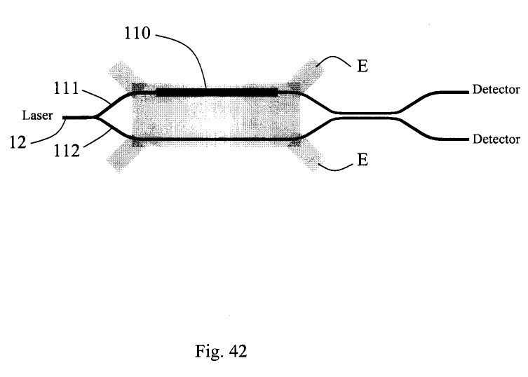

FIG. 42 shows an alternative arrangement for confining the environment E in a single channel such that the environment E surrounds both the sensing branch 111 and reference branch 112. An advantage of this arrangement compared to that shown in FIG. 41(b) is that the flow conditions of a fluid in the environment E may be automatically substantially identical along both branches 111 and 112. The Mach-Zehnder interferometers shown in FIGS. 41 (a) and (c) could likewise be incorporated into a single channel.

### EXAMPLE 25

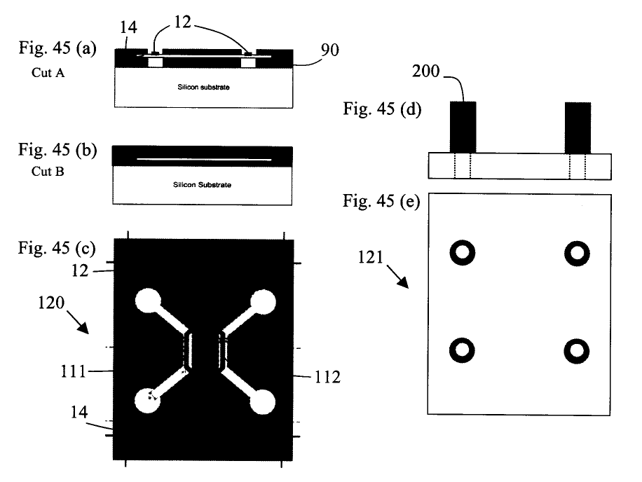

FIGS. 45(a) to 45(e) show an implementation of the Mach-Zehnder interferometer described under Example 21 and shown schematically in FIG. 41(a). In this implementation a bottom chip 120, shown schematically in cross-sectional view in FIGS. 45(a) and 45(b) and in top view in FIG. 45(c), is combined with a top chip 121 shown in cross-sectional view in FIG. 45(d) and in top view in FIG. 45(e), in order to enclose each of the branches 111 and 112 of the interferometer within the environment E, thus enabling independent addressing of a branch via the top chip fluid inlets/outlets 200. The channels confining the environment are formed within the transparent material 90, as shown in FIG. 45(a). This material is also used as an optical cladding in the regions away from the fluid, as shown in FIG. 45(b). Butt-coupling with optical fibres at the input and output of the chip is used. Suitable choices for the material 90 and the top chip 121 shown in FIGS. 45(d)-(e) are the same as those identified for the membrane with a particularly good choice being SiO₂ when the membrane is Si₃N₄.

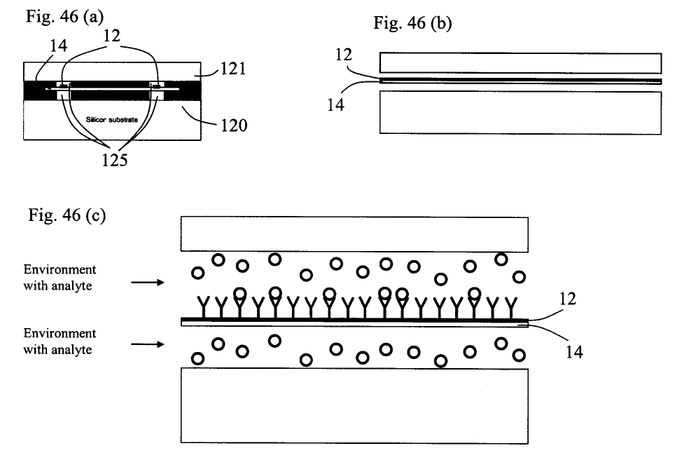

FIG. 46(a) shows a cross-sectional view taken along cut A of the assembly resulting from the combination of the bottom chip shown in FIGS. 45(a)-(c) and the top chip shown in FIGS. 45(d)-(e). Clamping the assembly with force or bonding the chips 120 and 121 using an adhesive ensures that the top and bottom chips 121 and 120 are sealed along the top surface of the bottom chip 120 thus ensuring that the environment E is contained within the channels 125.

FIG. 46(b) shows a partial longitudinal cross-sectional view of the assembly taken along one of the branches. FIG. 46(c) shows a partial longitudinal cross-sectional view of the assembly taken along the sensing branch 111 to illustrate bindings occurring between analyte (circles) in the environment E and receptors (Y's) coated onto the top surface of the strip 12. Any other Mach-Zehnder architecture, including those shown in FIGS. 41 (b) and (c), could be implemented in this manner.

It should be noted that the independent addressing of the sensing 111 and reference 112 branches by the environment E, as depicted via the implementation shown in FIGS. 45 and 46, allows bulk (refractometric sensing or homogeneous sensing) by comparing two fluids, one of which could be a control sample placed in the channel of the reference branch. Advantageously, the membrane waveguide allows virtually 100% of the mode field to sample the environment (as is noted by observing, say, FIG. 25 (b)) enabling very accurate bulk sensors.

### EXAMPLE 26

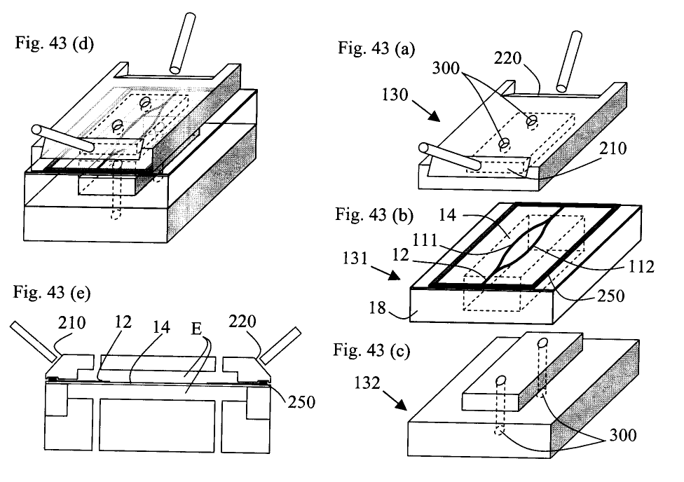

FIGS. 43(a) to 43(e) show an implementation of the Mach-Zehnder interferometer described under Example 24 and shown schematically in FIG. 42, except that the single output version is shown here. In this implementation a bottom chip 132, shown schematically in FIG. 43(c), and a top chip 130, shown schematically in FIG. 43(a), are combined with a middle chip 131 shown schematically in FIG. 43(b) in order to enclose an entire interferometer within the environment E, thus enabling simultaneous addressing of both branches 111 and 112 via the top and bottom chip fluid inlets/outlets 300. The assembly is shown schematically in FIG. 43(d) and in longitudinal central cross-sectional view in FIG. 43(e). As depicted in FIG. 43(a) and FIG. 43(e), the top chip has beveled edges 210 and 220 and is accurately spaced a distance s from the strip 12 by a spacer ring 250, effectively enabling evanescent prism coupling of the input/output light beams, as in FIG. 34 and FIGS. 33(c) and (d). FIG. 43(b) shows the spacer ring 250 as completely surrounding the membrane and thus serving the dual purpose of providing the required spacing s for efficient coupling and of providing a seal between the top chip and the middle chip. The membrane 14 depicted in FIG. 43 (b) is implemented as in FIG. 31, and the spacer ring 250 is located over the substrate 18, away from the membrane 14, hence allowing the top, middle and bottom chips 130, 131 and 132, respectively, to be clamped with force in the assembly shown in FIG. 43(d). Clamping with force or bonding using an adhesive ensures that the top and middle chips are sealed along the ring 250 and that the bottom and middle chips are sealed along the top surface of the bottom chip, as shown in FIGS. 43(d) and (e), thus ensuring that the environment E is contained.

Suitable choices for the material of the top chip 130 shown in FIG. 43(a) are the same as those identified for the membrane 14 with a particularly good choice being SiO₂. Many materials could be used for the bottom chip 132 with a particularly good choice being a thermally conductive material thus enabling control over the temperature of the environment E by controlling the temperature of the bottom chip 132. Many materials could be used for the spacer ring 250, suitable choices being materials which are conveniently deposited and patterned during fabrication of the middle chip 131. The metals identified for the strip 12 are particularly good choices for the spacer ring 250.

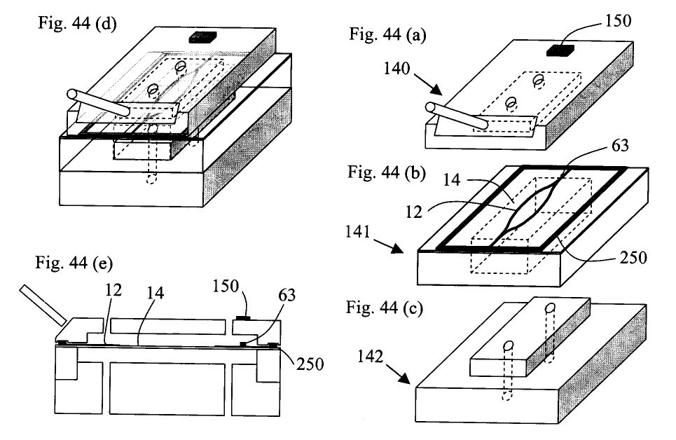

FIGS. 44(a) to 44(e) depict an arrangement similar to that shown in FIGS. 43(a) to 43(e) except that the output prism-like coupler partially defined by the beveled edge 220 is replaced with a scattering centre 63, similar to that shown in FIG. 37, and a detector or detector array 150 is positioned on the top surface of the top chip 140. Any other Mach-Zehnder architecture, including those shown in FIGS. 41 (b) and (c), could be implemented in this manner.

### EXAMPLE 27

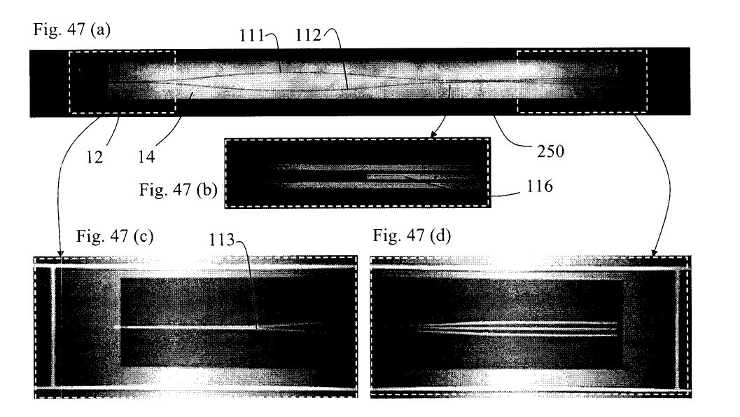

Triple output Mach-Zehnder interferometers have been fabricated having equal length sensing and reference branches, and designed in keeping with the architecture of the middle chip 131 shown schematically in FIG. 43 (b) and described under Example 26. The designs are consistent with: Example 7, using d=30 nm; Example 12, except using 5 nm of Cr followed by 15 nm of Au; Example 23 except configured for use with a single channel as described in Example 24; Example 14; Example 19 using t=20 nm and d=30 nm; and implemented as the clamped membrane 14 shown in FIG. 31. Microscope images of a typical fabricated structure are shown in FIG. 47. FIG. 47 (a) shows the full structure while FIGS. 47(b), 47(c) and 47(d) give higher magnification images of a portion of the triple output coupler 116, the input section with the input splitter 113, and the three output sections, respectively.

Specifically, this interferometer was designed for operation in an aqueous (water) environment at the free-space wavelength of 1310 nm. The 30 nm thick Si₃N₄ membrane 14 is 340 μm wide and 4081 μm long. The strip 12 is 5 μm wide and consists of a 20 nm thick metal stack comprising 5 nm of Cr used to promote the adhesion of Au to Si₃N₄ followed by 15 nm of Au. The frame 250 is 2.5 μm thick Au on a thin adhesion layer. Si was used as the substrate 18. The radius of curvature of all curved sections is 5500 μm, the path length of the sensing and reference branches (measured from the input split to the start of the output coupler) is 2246 μm, the edge-to-edge spacing between the branches at their largest separation is 142 μm, the edge-to-edge spacing between each adjacent pair of the three straight sections of the triple output coupler 116 is 1.9 μm and the length of each of the three straight sections of the triple output coupler 116 is 545 μm. The radius of curvature adopted yields substantially non-radiating curves. The dimensions cited for the triple output coupler 116 provide the desired 120° shift in the response of the three output powers versus the phase difference, as described under Example 23.

The modeling framework described in “Passive integrated optics elements based on long-range surface plasmon polaritons” by R. Charbonneau, C. Scales, I. Breukelaar, S. Fafard, N. Lahoud, G. Mattiussi and P. Berini, Journal of Lightwave Technology, Vol. 24, pp. 477-494, 2006 was combined with the coupled mode theories described in “Integrated optical Mach-Zehnder Biosensor” by B. J. Luff J. S. Wilkinson, J. Piehler, U. Hollenbach, J. Ingenhoff and N. Fabricius, Journal of Lightwave Technology, Vol. 16, pp. 583-592, 1998 and “Application of the strongly coupled-mode theory to integrated optical devices” by S.-L. Chuang, IEEE Journal of Quantum Electronics, Vol. QE-23, pp. 499-509, 1987, in order to model the full end-to-end structure, including the triple output coupler 116. The model was then used to explore the design space of the structure and arrive at the dimensions given above which yield an acceptably low optical insertion loss, a high waveguide surface sensitivity ∂n_{eff}/∂α and a high overall sensitivity given the long optical length of the sensing branch and reference branch.

For sensing and reference branches of equal length L and identical design (and hence of identical effective refractive index), the phase difference Δφ due to the presence of the adlayer is given by Δφ=2πLΔn_{eff}/λ₀ where Δn_{eff}=aₜ∂n_{eff}/∂a is the change in the effective index of the sensing branch due to the adlayer of thickness aₜ. The maximum length selected for the sensing and reference branches 111 and 112 will be determined either by the maximum tolerable insertion loss of the branches or by another constraint such as, for example, the diameter of the substrate wafer upon which the devices are fabricated.

In the case of the former, it is useful to consider the expression for the phase difference in terms of the insertion loss instead of the length L. Recalling that the insertion loss IL (in dB) of a waveguide of length L and attenuation α (in m⁻¹) is IL=−10 log₁₀(e^{-2αL}), it is straightforward to express the phase difference as Δφ=(β₀/α)(∂n_{eff}/∂a)aₜ(IL/20)ln(10). Based upon this expression, a figure of merit G is defined as G=(∂n_{eff}/∂a)/(α/β₀), i.e.: as the ratio of the waveguide sensitivity ∂n_{eff}/∂a to its normalized attenuation α/β₀. The phase difference in terms of this figure of merit G is then Δφ=Gaₜ(IL/20)ln(10). Clearly, the larger the value of G, the larger the phase difference for a given adlayer thickness at and branch insertion loss IL. The figure of merit is useful since it contains all waveguide performance parameters of relevance to a surface sensor based on the Mach-Zehnder interferometer (∂n_{eff}/∂a and α) as well as the operating free-space wavelength (through β₀). The value of figure of merit G can be computed over the design space of the waveguide (w, t, d; see FIG. 38) for a chosen combination of materials and as a function of wavelength. Particularly good embodiments have a large figure of merit G.

### EXAMPLE 28

was selected as the material for the membrane 14, Au was selected as the material for the strip 12 and water was selected for the environment E. The width w of the strip 12 was set to a value that, in effect, was infinite, its thickness t was varied in the range from 1 nm to 40 nm and the thickness d of the membrane 14 was varied from 1 to 40 nm. The figure of merit G was computed for each combination of t and d within these ranges at operating free-space wavelengths in the range from 600 to 1600 nm. The relative permittivities of Si₃N₄ and Au, respectively, were obtained from “Handbook of Optical Constants of Solids”, Edited by E. D. Palik, Academic Press, 1985, and of water from “The complex refractive index of water” by D. J. Segelstein, M. S. Thesis, Department of Physics, University of Missouri—Kansas City, 1981, over the operating free-space wavelength range of interest and the permittivities were interpolated as needed for each wavelength.

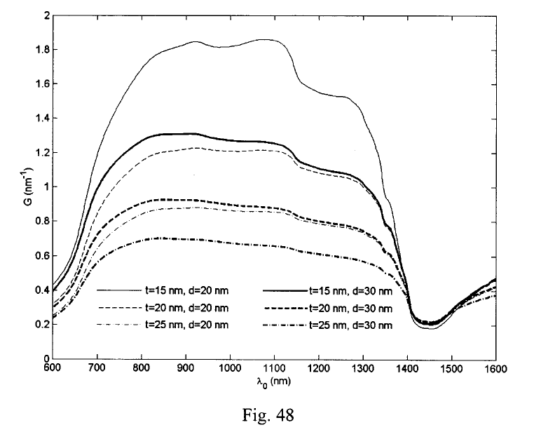

FIG. 48 gives figure of merit G as a function of the operating free-space wavelength λ₀ for six combinations of t and d. The relative merit of these combinations, and of different operating free-space wavelengths, can be compared directly. It is immediately observed that the free-space wavelength range from about 630 nm to about 1350 nm is good, with good choices being wavelengths where high quality and compact lasers are available such as, for example, 632.8, 785, 850, 980 and 1310 nm. 850 nm is a particularly good choice since the value of figure of merit G exhibits a maximum near this operating free-space wavelength for all combinations of d and t considered. It is also observed that a thinner strip 12 combined with a thinner membrane 14 leads to a greater value of figure of merit G. Particularly good combinations are t=15 nm with d=20 nm, t=15 nm with d=30 nm and t=20 nm with d=20 nm.

### EXAMPLE 29

The free-space operating wavelength was set to 850 nm, Si₃N₄ (ε_{r,2}=1.95²) was selected as the material for the membrane 14, Au (ε_{r,3}=−31.22−j2.194) was selected as the material of the strip 12, water (ε_{r,1}=(1.3247−j2.9680×10⁻⁷)²) was selected for the environment E, and an adlayer model typical of biological materials was selected (n_{α}=1.5, α=3 nm). The width w of the strip 12 was set large enough to constitute infinite width and its thickness t was varied over the range 1≦t≦40 nm, while the thickness d of the membrane 14 was varied over the range 1≦d≦40 nm.

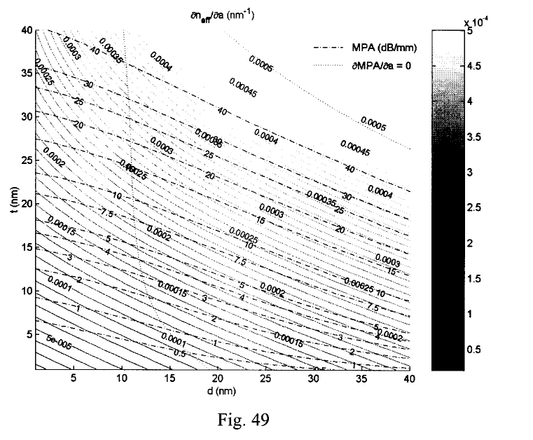

FIG. 49 gives the computed sensitivity ∂n_{eff}/∂α in nm⁻¹ of the ss_{b}⁰ mode over these ranges of strip and membrane thickness t and d. The computed sensitivities are plotted as solid gray-scaled constant-valued contours. The associated mode power attenuation (MPA) is also plotted in dB/mm for reference as the labeled dash-dot constant-valued contours. The associated mode power attenuation null sensitivity ∂MPA/∂α=0 is plotted for reference as the dotted constant-valued contour. The waveguide attenuation does not change with small changes in a for thicknesses (t, d) on this contour. In fact for dimensions everywhere inside of the region delimited by the contour, the attenuation sensitivity ∂MPA/∂α is very low.

For widths greater than about 2 μm, the results plotted in FIG. 49 did not change very much with strip width w.

Because a membrane waveguide embodying the present invention comprises a strip 12 of relatively high free charge carrier density, in addition to guiding the ss_{b}⁰ mode, the strip 12 could act as an electrical conductor or as an electrode. To achieve this, non-optically invasive electrical contacts to the strip 12 can be implemented, for example, as thin, narrow arms protruding substantially perpendicularly from the strip 12 and ending in large area contact pads in a region away from the membrane and overlying the substrate 18.

### EXAMPLE 30

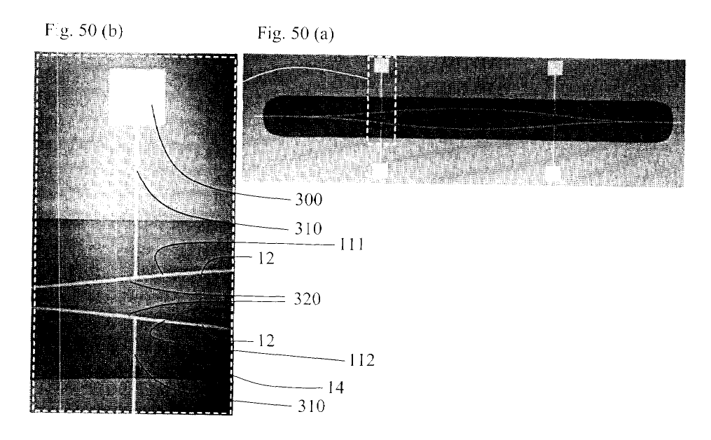

Such contact arms are shown in FIG. 50, which shows microscope images of a typical fabricated interferometer structure embodying the invention and having electrical contacts to the strip 12 of each branch. The structure shown is a single output equal arm Mach-Zehnder interferometer, similar in design and fabrication to the structure shown in FIG. 47 and discussed under Example 27. FIG. 50(a) shows the full structure while FIG. 50(b) gives a higher magnification image of a portion of the Mach-Zehnder interferometer, showing in detail electrical contacts to the strips 12. Each contact comprises a substantially optically non-invasive arm 310 protruding substantially perpendicularly from the strip 12 and ending in a contact pad 300, and substantially optically non-invasive isolation gaps 320 which are introduced into the strips 12 in order to confine the electrical connection to the sensing and reference branches 111 and 112, respectively (add to FIG. 50(b)).

In this embodiment, two electrical contacts and two isolation gaps 320 are used for each branch in order to provide full, isolated and independent electrical access to each. The pair of contacts to each branch can be seen in Part (a) but the isolation gaps are not visible due to the low magnification of this image. Specifically, this interferometer was designed for operation in an aqueous (water) environment at the free-space wavelength of 1310 nm. The 30 nm thick Si₃N₄ membrane 14 is about 340 μm wide and 3043 μm long. The strip 12 is 5 μm wide and consists of a 20 nm thick metal stack comprising 5 nm of Cr used to promote the adhesion of Au to Si₃N₄ followed by 15 nm of Au. Si was used as the substrate 18.

The radius of curvature of all curved sections is 5500 μm, the path length of the sensing and reference branches (measured from the input split to the output split) is 2108 μm and the edge-to-edge spacing between the branches at their largest separation is 137 μm. The radius of curvature adopted yields substantially non-radiating curves. The thin narrow arms 310 are 5 μm wide and of identical thickness and composition to the strip 12 since the arms and the strip were fabricated simultaneously. The narrow isolation gaps 320 are 2 μm in length. The arms 310 and gaps 320 designed and implemented in this manner are substantially optically non-invasive. The contact pads 300 are dimensioned 100×100 μm and are positioned away from the membrane 14 in regions overlying the substrate 18 in order to facilitate in a robust manner contacting or bonding with electrical wires, probes or other electrical interfacing means.

Making electrical contact with a Mach-Zehnder interferometer in the manner shown in FIG. 50 and as described under Example 30 provides advantages and added functionality. For instance, a current source can be connected to a pair of contacts on the same branch in order to pass a current through the strip 12 of the branch thus heating the strip (due to ohmic loss) and the surrounding environment near the strip. Such heating impacts the adsorption and desorption of analyte to receptor, and hence the kinetics of the reaction, and of receptor chemistry to strip. Heating the strip can also completely desorb material adsorbed onto the strip, including the receptor chemistry if it is appropriately chosen and desirable to do so.

Heating as described may also provide for the region of the environment in the immediate proximity of the strip to be thermally stabilized, improving the signal to noise ratio of the detected output optical signals. This thermally stabilized region is also useful for controlling the temperature at which reactions between the analyte and receptor occur, or for thermally influencing chemical reactions within the environment itself. Using an alternating current in one branch provides all of the benefits described above but additionally adds a phase modulation of known frequency onto the ss_{b}⁰ mode propagating along the branch, which is useful for further improving the signal to noise ratio of the detected output optical signals. Modulation of the ss_{b}⁰ mode is achieved via the thermo-optic effect, present in the strip material 12 and in the environment E if it is aqueous or another liquid. It is noted that metals such as Au and water have high thermo-optic coefficients.

The alternating current can be one of various waveforms including sinusoidal, triangular, rectangular and pulsed. Current can be passed in the manner described above through the sensing branch only, the reference branch only or both as dictated by the application.

As an alternative to passing a current through the strip 12, a voltage can be applied to the strip 12 of a branch and a grounded electrode can be brought into close proximity above the branch, thus establishing an electric field within the environment between the strip and the electrode. Such an arrangement allows the principles and methods of electrophoresis and dielectrophoresis to be applied to embodiments of the invention. In the case of the former, for instance, the applied field influences electrically charged analyte (positive or negative) by inducing a drift component of velocity to the diffusing analyte. The polarity of the applied voltage is easily selected to accommodate the type of charge present in the analyte in order to achieve drift toward the sensing branch. A voltage of the opposite polarity could be simultaneously applied to the reference branch in order to repel analyte from the branch.

The applied voltages, and hence the established electric fields, can be alternating, and have various waveforms including sinusoidal, triangular, rectangular or pulsed. Pulses are particularly useful for desorbing non-specifically bound and charged species to the sensing and reference arms since short high-voltage pulses can be applied to repel species that are non-specifically and weakly bound to the surface while retaining the strongly and specifically bound analyte.

Connecting electrically to the branches also allows electrochemical principles and methods to be used in conjunction with embodiments of the invention.

It should be appreciated that other structures such as, for example, straight sections, dual and triple output Mach-Zehnder interferometers, non-equal arm Mach-Zehnder interferometers, dual and triple strip couplers, and other similar structures comprising waveguide structures embodying this invention could be contacted electrically and used in the manner described above.

Optical devices embodying the invention may be implemented in integrated optics products.

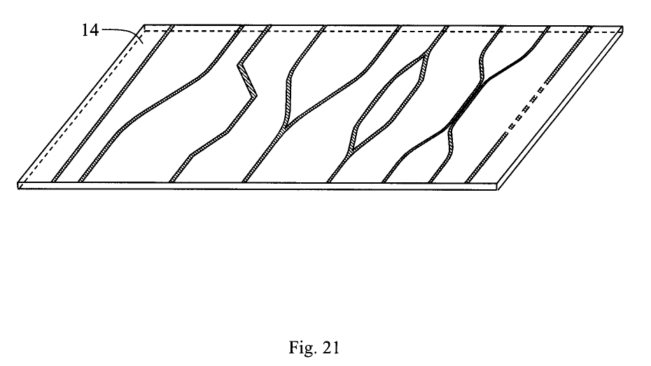

Embodiments of the invention may be useful for signal transmission and routing or to construct components such as couplers, power splitters/combiners, interferometers, modulators, switches, periodic structures and other typical components of integrated optics products. Thus, FIG. 21 illustrates examples of passive devices employing straight, curved, S-bent, tapered and step-in-width interconnection elements which can be implemented. A two-way splitter can be implemented as a Y-junction; a Mach-Zehnder interferometer can be implemented as two such Y-junctions connected back-to-back, with or without intervening straight interconnections; a multimode interferometer can be implemented using a widened strip appropriately interconnected with such waveguides in a manner known to those skilled in the art of integrated optics; 2×2 couplers can be implemented as parallel coupled strips, as shown in FIG. 21; and N-way splitters and N-way couplers can be implemented using a plurality of strips. For example, and without limitation or prejudice, a Mach-Zehnder interferometer was shown in FIGS. 31, 32 and 33 instead of a straight waveguide as in FIG. 3. Also, periodic structures and Bragg gratings can be implemented according to the teachings of U.S. Pat. No. 6,823,111, the contents of which are incorporated herein by reference and to which the reader is directed for reference, but using waveguide structures embodying the present invention instead of those disclosed therein.

Indeed, for some applications, waveguide structures embodying the present invention can be substituted for waveguide structures disclosed in the above-mentioned U.S. Pat. Nos. 6,442,321, 6,614,960, 6,741,782, 6,801,691 and 6,823,111.

It should be noted that these prior patents would lead a skilled addressee to conclude that a membrane could not be interposed between the strip 12 and its surroundings or environment E without causing significant deleterious performance. The present invention is predicated upon the unexpected discovery that, providing certain conditions are met, a practically realizable membrane can be interposed without severely deleteriously affecting propagation of the plasmon-polariton wave, for example the long-range ss_{b}⁰ mode.

An advantage of embodiments of the present invention is that the membrane 14 can be arranged to support the strip 12 in an environment that is liquid, gaseous or vacuum. It should be appreciated that suitable seals will be provided depending upon whether a vacuum or a fluid, i.e., a gas or a liquid, is used. The design of suitable seals is well within the knowledge of the skilled addressee and so will not be described in detail herein.

An advantage of the use of a membrane by embodiments of the present invention is that it is relatively simple to ensure that the optical properties of the environment E around the strip are substantially the same.

Since the mode is a surface wave, then virtually 100% of the ss_{b}⁰ mode fields sample the environment in such an arrangement. This in turn enables numerous devices and components such as: tunable components using a liquid crystal as the environment, optical amplifiers and oscillators using gases or liquids exhibiting optical gain as the environment, and chemical and biochemical sensors operating in gaseous or liquid environments.

It should be noted that the means for confining the environment around the strip 12 could be omitted and the strip 12, membrane 14 and supporting structure inserted into a container or conduit for holding or passing a fluid to be sensed. Moreover, the confining means could comprise a cavity on only one side of the membrane, allowing comparative sensing between a fluid in the cavity and a fluid on the other side of the membrane.

1-44. (canceled)

45. An optical device characterized by a waveguide structure comprising:
a thin strip (12) having finite width and thickness of material having a relatively high free charge carrier density supported by a membrane (14) having a predetermined thickness of material that has a relatively low free charge carrier density,
the dimensions of the width and thickness of the strip and the thickness of the supporting membrane being such that, when the waveguide structure is surrounded at least partially by an environment (E) having a low free charge carrier density, optical radiation having a wavelength in a predetermined range couples to the waveguide structure and propagates along the length thereof as a plasmon-polariton wave that permeates at least part of the environment (E).

46. An optical device according to claim 45, characterized in that the membrane covers a surface of the strip and is substantially non-invasive optically.

47. An optical device according to claim 45, characterized in that the membrane (14) has a plurality of apertures (26) spaced apart along its length, said juxtaposed portion of the strip comprising parts (28) of the strip exposed through respective ones of said apertures, and margin portions (30) of the strip (12) around the exposed parts (28) overlie and are attached to respective parts (32) of the membrane (14) and, preferably, also characterized in that the exposed parts (28) of the strip each extend into the respective one of the apertures (26).

4. An optical device according to claim 45, further characterized by means (16) for confining adjacent at least one side of said strip (12) at least a part of said environment (E) that comprises either or both of a vacuum and a fluid and the membrane (14) supports said strip (12) such that the waveguide structure extends at least partially within the confined environment and, preferably, also characterized in that the confining means comprises a channel (16) and the membrane (14) divides the channel longitudinally into two cavities (16′, 16″), the strip (12) extending longitudinally and medially along the membrane.

49. An optical device according to claim 45, further characterized by:
means (20) for coupling input light in an endfire manner to one end of said strip (12) so as to propagate along said strip as said plasmon-polariton wave.

50. An optical device according to claim 45, further characterized by:
means (20,60) for coupling input light laterally to said strip (12) to propagate along said strip as said plasmon-polariton wave and, preferably, also further characterized by:
means (22) for extracting at least part of said plasmon-polariton wave in an endfire manner at an opposite end of said strip (12) or
means (22,62) for extracting at least part of said plasmon-polariton wave laterally from said strip.

51. An optical device according to claim 45, characterized in that the strip (12) comprises a material that is selected from the group comprising metals, semi-metals, highly n- or p-doped semiconductors and materials that behave like a metal at an operating wavelength of the waveguide structure and, preferably, characterized in that the strip (12) comprises a single metal or a combination of metals as alloys or laminates, the strip (12) comprising, for example, a metal selected from the group Au, Ag, Cu, Al, Pt, Pd, Ti, Ni, Mo and Cr, preferably Au, Ag, Cu and Al, with Au being particularly preferred.

52. An optical device according to claim 51, characterized in that the strip (12) comprises a metal silicide or a semiconductor, for example highly n- or p-doped GaAs, InP, Si and Ge.

53. An optical device according to claim 51, characterized in that the strip (12) comprises Indium Tin Oxide (ITO) that behaves like a metal at an operating wavelength of the waveguide structure.

54. An optical device according to claim 52, characterized in that the strip (12) comprises CoSi2 and the membrane comprises Si.

55. An optical device according to claim 45, characterized in that the device is adapted for use in sensing a body in the environment (E), the strip comprising a material that reacts with the body.

56. An optical device according to claim 55, characterized in that the strip is formed entirely from said material, or characterized in that the strip has a surface layer of said material, e.g., as an adlayer.

57. An optical device according to claim 56, for use in sensing a body comprising an analyte of, for example, a chemical or biological nature, characterised in that the material, i.e., adlayer, comprises receptors for binding with the analytes.

58. An optical device according to claim 51, characterized in that the material of the membrane structure (14) comprises an optical dielectric, for example glass, quartz, polymer, SiO2, Si3N4, silicon oxynitride (SiON), LiNbO3, PLZT, and undoped or very lightly doped semiconductors such as GaAs, InP, Si and Ge, with SiO2, SiON or Si3N4 being preferred, or characterized in that the material of the membrane structure (14) is a polymer selected from the group comprising BCB, polyimide, PMMA, Teflon AF (TM), SU8.

59. An optical device according to claim 45, adapted for operation with light having a free-space wavelength of about 1550 nm, characterized in that the membrane structure comprises SiO2 (er,2=1.4442), the strip comprises Au (er,3=−131.95−j12.65) and said part of the environment (E) comprises vacuum (er,1=1), the width w of the strip 12 being about 8 mm, thickness t of the strip being about 30 nm, and the thickness d of the membrane (14) being in the range from substantially 0 to about 65 nm, preferably about 20 nm.

60. An optical device according to claim 45, adapted for operation with light having a free-space wavelength of about 1310 nm, characterized in that the material of the membrane comprises SiO2 (er,2=1.44682), the material of the strip comprises Au (er,3=−86.08−j8.322) and said part of the environment (E) comprises vacuum (er,1=1), the width w of the strip being about 6 mm, the thickness t of the strip being about 30 nm, and the thickness d of the membrane being in the range from about substantially 0 to about 55 nm, preferably about 20 nm.

61. An optical device according to claim 45, adapted for operation with light having a free-space wavelength of about 1310 nm, characterized in that the material of the membrane comprises SiO2 (er,2=1.44682), the material of the strip comprises Au (er,3=−86.08−j8.322), and said part of the environment (E) comprises water (er,1=(1.3159−j1.639′10-5)2), the width w of the strip 12 being about 3 mm, the thickness t of the strip being about 20 nm, and the thickness d of the membrane (14) being in the range from about 0 to about 100 nm, preferably about 20 nm.

62. An optical device according to claim 45, adapted for operation with light having a free-space wavelength of about 1310 nm, characterized in that the material of the membrane comprises Si3N4 (er,2=22), the material of the strip comprises Au (er,3=−86.08−j8.322), and said part of the environment comprises water (er,1=(1.3159−j1.639′10-5)2), the width w of the strip (12) being about 6 mm, the thickness t of the strip being about 25 nm, and the thickness d of the membrane (14) being in the range from about substantially 0 to about 40 nm, preferably about 20 nm.

63. An optical device according to claim 45, adapted for operation with light having a free-space wavelength of 632.8 nm, characterized in that the material of the membrane (14) comprises Si3N4 (er,2=2.02112), the material of the strip (12) comprises Au (er,3=−11.7851−j1.2562), and said part of the environment (E) comprises water (er,1=(1.3313−j1.552′10-8)2), the width w of the strip 12 being about 2 mm, the thickness t of the strip being about 17 nm, and the thickness d of the membrane (14) being in the range from about substantially 0 to about 40 nm, preferably about 20 nm.

64. An optical device according to claim 45, adapted for operation with input light having a free-space operating wavelength of about 1550 nm, characterized in that the membrane 14 comprises SiO2, the strip comprises Au, and the environment comprises a vacuum or is gaseous, the width w and thickness t of the strip are about 8 mm and 30 nm and the thickness d of the membrane is about 20 nm. (Example 1)

65. An optical device according to claim 45, adapted for operation with input light having a free-space operating wavelength of about 1310 nm, characterized in that the membrane 14 comprises SiO2, the strip comprises Au, and the environment comprises a vacuum or is gaseous, the width w and thickness t of the strip are about 6 mm and 30 nm and the thickness d of the membrane is about 20 nm. (Example 2)

66. An optical device according to claim 45, adapted for operation with input light having a free-space operating wavelength of about 1310 nm, characterized in that the membrane 14 comprises SiO2, the strip comprises Au, and the environment is aqueous, the width w and thickness t of the strip are about 3 mm and 20 nm and the thickness d of the membrane is about 20 nm. (Example 3)

67. An optical device according to claim 45, adapted for operation with input light having a free-space operating wavelength of about 1310 nm, characterized in that the membrane 14 comprises Si3N4, the strip comprises Au, and the environment is aqueous, the width w and thickness t of the strip are about 6 mm and 25 nm and the thickness d of the membrane is about 20 nm. (Example 4)

68. An optical device according to claim 45, adapted for operation with input light having a free-space operating wavelength of about 632.8 nm, characterized in that the membrane 14 comprises Si3N4, the strip comprises Au, and the environment is aqueous, the width w and thickness t of the strip are about 2 mm and 17 nm and the thickness d of the membrane is about 20 nm. (Example 5)

69. An optical device according to claim 45, adapted for operation with input light having a free-space operating wavelength of about 1310 nm, characterized in that the membrane 14 comprises Si3N4, the strip comprises Au, and the environment is aqueous, the width w and thickness t of the strip are about 5 mm and 25 nm and the thickness d of the membrane is about 20 nm. (Example 6)

70. An optical device according to claim 45, adapted for operation with input light having a free-space operating wavelength of about 1310 nm, characterized in that the membrane 14 comprises Si3N4, the strip comprises Au, and the environment is aqueous, the width w and thickness t of the strip are about 5 mm and 20 nm and the thickness d of the membrane is about 30 nm. (Example 7)

71. An optical device according to claim 45, adapted for operation with input light having a free-space operating wavelength of about 632.8 nm, characterized in that the membrane 14 comprises Si3N4, the strip comprises Au, and the environment is vacuum, gaseous or aqueous, the width w and thickness t of the strip are about 1 mm and 25 nm and the thickness d of the membrane is about 20 nm. (Example 8)

72. An optical device according to claim 45, adapted for operation with input light having a free-space operating wavelength of about 632.8 nm, characterized in that the membrane 14 comprises Si3N4, the strip comprises Au, and the environment is vacuum, gaseous or aqueous, the width w of the strip is about 1.25 mm, the thickness t of the strip is in the range from 20 nm to 25 nm and the thickness d of the membrane is about 20 nm. (Examples 9,10)

73. An optical device according to claim 45, adapted for operation with input light having a free-space operating wavelength of about 1310 nm, characterized in that the membrane 14 comprises Si3N4, the strip comprises Au, and the environment is vacuum, gaseous or aqueous, the width w and thickness t of the strip are about 5 mm and 25 nm and the thickness d of the membrane is about 20 nm. (Example 11)

74. An optical device according to claim 45, adapted for operation with input light having a free-space operating wavelength in the range from about 600 nm to about 1600 nm, characterized in that the membrane 14 comprises SiO2, the strip comprises Au, the environment is vacuum, gaseous or aqueous, the width w is in the range from about 1 mm to about 10 mm, the thickness t of the strip is in the range from about 5 nm to about 50 nm and the thickness d of the membrane is in the range from about 5 nm to about 80 nm.

75. An optical device according to claim 45, adapted for operation with input light having a free-space operating wavelength in the range from about 600 nm to about 1600 nm, characterized in that the membrane 14 comprises Si3N4, the strip comprises Au, the environment is vacuum, gaseous or aqueous, the width w is in the range from about 1 mm to about 10 mm, the thickness t of the strip is in the range from about 5 nm to about 50 nm and the thickness d of the membrane is in the range from about 5 nm to about 40 nm.
